(19) United States
(12) Patent Application Publication
(10) Pub. No.: US 2013/0100346 A1
(43) Pub. Date: Apr. 25, 2013

(54) VIDEO PROCESSING DEVICE, VIDEO DISPLAY DEVICE, VIDEO RECORDING DEVICE, VIDEO PROCESSING METHOD, AND RECORDING MEDIUM

(71) Applicants: Isao OTSUKA, TOKYO (JP); Tomonori FUKUTA, TOKYO (JP)

(72) Inventors: Isao OTSUKA, TOKYO (JP); Tomonori FUKUTA, TOKYO (JP)

(21) Appl. No.: 13/616,563

(22) Filed: Sep. 14, 2012

(30) Foreign Application Priority Data
Oct. 19, 2011 (JP) 2011-229640
Feb. 10, 2012 (JP) 2012-026852

(51) Int. Cl. H04N 7/00

(52) U.S. Cl. 348/462; 348/E07.002

(57) ABSTRACT

A video processing device includes: a telop detector for detecting a telop area including a telop in an input sequence of video frames; an audio alert detector for detecting an audio alert from an input sequence of audio signals corresponding to the input sequence of video frames; and a video processor for replacing a telop area in the video frame in which the telop area is detected with an image derived from a video frame preceding the video frame in which the telop of the telop area initially appears in the input sequence of video frames, and outputting the video frame in which the telop area has been replaced. The video processor selectively replaces the telop area of a telop accompanied by an audio alert detected by the audio alert detector.

### BACKGROUND OF THE INVENTION

1. Field of the Invention

The present invention relates to a video processing device, a video display device, a video recording device, a video processing method, and recording medium.

2. Description of the Related Art

The video signals used in digital television broadcasting may include a telop that is superimposed on the video picture to provide information extraneous to the broadcast program content or original content, such as a news flash, earthquake prompt report, or simply the current time.

Particularly when the information concerns an impending natural calamity such as a flood, earthquake, tornado, or typhoon, a security emergency such as a missile or terrorist attack, or some other urgent event, the telop may be accompanied by an audio alert such as a bell tone, chime tone, beep tone, or melody to draw the viewer's attention to the telop. The audio alert may come before, during, or after the telop display.

In some circumstances, however the viewer has no need to see the telop or hear its audio alert. In particular, when the broadcast audio and video signals are recorded for later reproduction and viewing, enough time may elapse between recording and viewing that the information in the telop no longer has any current relevance.

In Japanese Patent Application Publication No. 2007-336405, Murakoshi describes a technique for removing a telop from a first video signal by substituting an enlarged portion of a second video signal, which lacks the telop, into the telop area. Specifically, the first video signal is a high-definition signal using twelve of the thirteen Japanese terrestrial digital broadcast segments, and the second signal is a low-definition signal using the remaining one segment to broadcast the same picture at a lower resolution.

In an article in the January 2009 issue of Toranjisuta Gijutsu (Transistor Technology), Asakura describes a method of recognizing the chime tone of a radio earthquake alert by monitoring the broadcast radio signal and comparing the amplitude of four frequencies in the broadcast audio signal with threshold values, in order to turn the radio on when a chime is detected.

### SUMMARY OF THE INVENTION

In an aspect of the present invention, it is intended to provide a video processing device, video display device, video recording device, video processing method, and recording medium that can selectively erase a telop accompanied by an audio alert.

According to an aspect of the present invention, there is provided a video processing device including: a telop detector for detecting a telop area including a telop in an input sequence of video frames; an audio alert detector for detecting an audio alert from an input sequence of audio signals corresponding to the input sequence of video frames; and a video processor for replacing a telop area in the video frame in which the telop area is detected with an image derived from a video frame preceding the video frame in which the telop of the telop area initially appears in the input sequence of video frames, and outputting the video frame in which the telop area has been replaced. The video processor selectively replaces the telop area of a telop accompanied by an audio alert detected by the audio alert detector.

According to another aspect of the present invention, there is provided a video display device including: the above described video processing device; and a reproduction unit for displaying video frames output from the video processor in the video processing device.

According to still another aspect of the present invention, there is provided a video recording device including: the above described video processing device; and a recording unit for recording video frames output from the video processor in the video processing device.

According to still another aspect of the present invention, there is provided a method of processing an input sequence of video frames, including: detecting a telop area including a telop in an input sequence of video frames; detecting an audio alert from an input sequence of audio signals corresponding to the input sequence of video frames; and replacing a telop area in the video frame in which the telop area is detected with an image derived from a video frame preceding the video frame in which the telop initially appears in the input sequence of video frames, and outputting the video frame in which the telop area has been replaced. The telop area of a telop accompanied by an audio alert detected in the audio alert detection is selectively replaced.

According to still another aspect of the present invention, there is provided a machine-readable recording medium storing a program executable by a computer, the program including: instructions for detecting a telop area including a telop in an input sequence of video frames; instructions for detecting an audio alert from an input sequence of audio signals corresponding to the input sequence of video frames; and instructions for replacing a telop area in the video frame in which the telop area is detected with an image derived from a video frame preceding the video frame in which the telop initially appears in the input sequence of video frames, and outputting the video frame in which the telop area has been replaced. The telop area of a telop accompanied by an audio alert detected in the audio alert detection is selectively replaced.

### BRIEF DESCRIPTION OF THE DRAWINGS

In the attached drawings:

FIG. 1 is a block diagram illustrating the structure of a video processing device according to a first embodiment of the invention;

FIG. 2 is a block diagram illustrating the structure of the video recording unit in FIG. 1;

FIG. 3 shows an exemplary telop area included in a video frame;

FIG. 4 is a flowchart illustrating the operation of the video processing device in the first embodiment;

FIG. 5 is an exemplary telop transition diagram;

FIGS. 6 and 7 illustrate exemplary states of the video recording unit in FIG. 1;

FIG. 8 is another exemplary telop transition diagram;

FIG. 9 is a block diagram illustrating the structure of a video processing device according to a second embodiment of the invention;

FIG. 10 illustrates information detected by the telop change detector in FIG. 9;

FIG. 11 shows an exemplary telop;

FIG. 12 illustrates detection of a telop change by the telop change detector;

FIGS. 13 and 14 illustrate replacement of a telop area by using peripheral pixels;

FIG. 15 illustrates decision results in step S405 in the second embodiment;

FIG. 16 is a block diagram illustrating the structure of a video processing device according to a third embodiment of the invention;

FIG. 17 is a flowchart illustrating the operation of the video processing device in the third embodiment;

FIG. 18 is a block diagram illustrating the structure of a video processing device according to a fourth embodiment;

FIG. 19 is a block diagram illustrating the structure of a video processing device according to a fifth embodiment;

FIG. 20 is a block diagram illustrating the structure of a video processing device according to a sixth embodiment;

FIG. 21 is a block diagram illustrating the structure of a video processing device according to a seventh embodiment;

FIG. 22 is a flowchart illustrating the operation of the video processing device in the seventh embodiment;

FIGS. 23, 24, and 25 illustrate telop transitions accompanied by audio alerts;

FIG. 26 is a flowchart illustrating the operation of the video processing device in an eighth embodiment of the invention;

FIG. 27 is a flowchart illustrating the operation of the video processing device in a ninth embodiment;

FIG. 28 is a block diagram illustrating the structure of a video processing device according to a tenth embodiment;

FIG. 29 is a block diagram illustrating the structure of a video display device according to an eleventh embodiment;

FIG. 30 is a block diagram illustrating the structure of a video recorder according to a twelfth embodiment;

FIG. 31 is a block diagram illustrating the structure of a video recording and reproducing device according to a thirteenth embodiment; and

FIG. 32 is a block diagram illustrating a variation of the video processing device.

### DETAILED DESCRIPTION OF THE INVENTION

Embodiments of the invention will now be described with reference to the attached drawings, in which like elements are indicated by like reference characters.

### First Embodiment

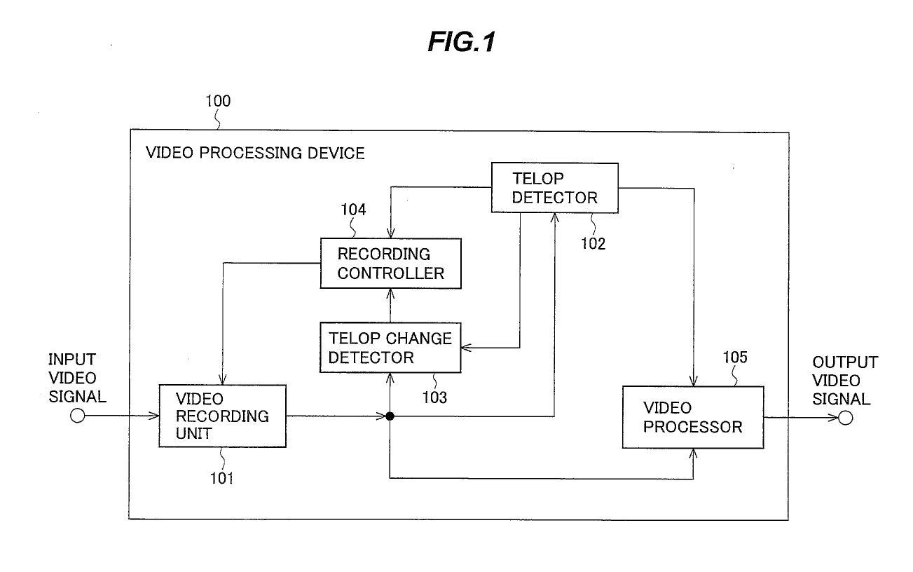

Referring to FIG. 1, the video processing device 100 in the first embodiment receives a sequence of video signals at an input terminal, detects telop areas including telops in the video signals, and performs replacement or interpolation on the detected telop areas to output video signals in which the telops have been erased. The input video signals are, for example, high-definition television broadcast signals such as the twelve-segment signals of digital terrestrial broadcasting in Japan. A telop is information such as text information, symbolic information, or graphics information that is superimposed on, inserted into, or combined with the video picture (the main picture or original picture). A telop might indicate the current time, an urgent earthquake report, a news flash, a subtitle, or other such information. Depending on the country, content, and format, the telop may be referred to as a caption, a subtitle, an alert, a ticker, a crawler, or a superimpose.

The video processing device 100 in FIG. 1 includes a video recording unit 101, a telop detector 102, a telop change detector 103, a recording controller 104, and a video processor 105.

As the input sequence of video signals, the video recording unit 101 receives a sequence of video frames and records them in an incoming memory. The term ‘video frame’ indicates each static picture constituting a moving picture. The video frame will be simply referred to as ‘frame’ in some cases. Specifically, the video recording unit 101 receives the sequence of video frames in series and records the current video frame, a video frame preceding the current video frame, and when a telop appears, a video frame preceding the appearance of the telop. Preferably, a video frame immediately preceding the appearance of the telop is recorded. In the present embodiment, the video frame one frame before the appearance of the telop is recorded. However, any video frame two or more frames before the appearance of the telop may be recorded, provided it is close enough to the appearance of the telop to provide a good basis for replacement or interpolation.

The terms ‘appearance’ and ‘initial appearance’ will be used synonymously below.

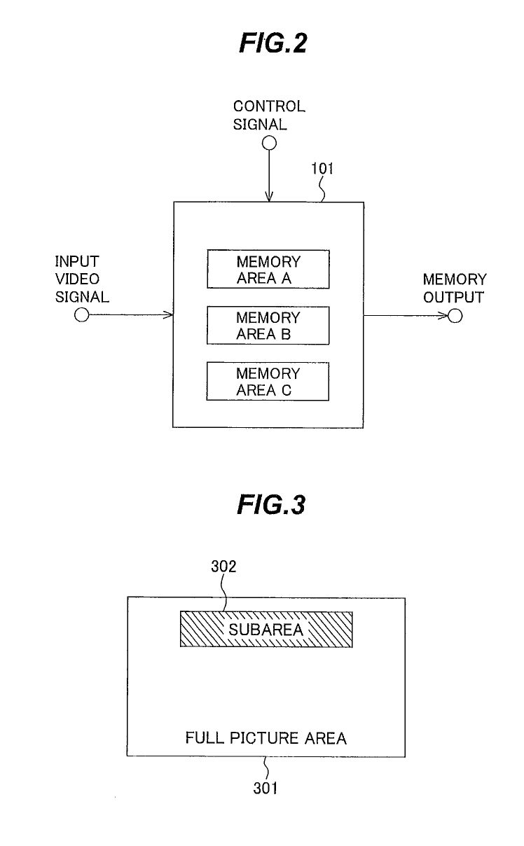

As shown in FIG. 2, the video recording unit 101 in this embodiment has memory areas A, B, and C. The video recording unit 101 manages these memory areas under control of the recording controller 104. Specifically, the video recording unit 101 records the current video frame and the Immediately preceding video frame in memory areas B and C and the video frame immediately preceding the appearance of a telop in memory area A. The video recording unit 101 is a frame memory that records the video signal of a single frame in each of the memory areas. Alternatively, the video recording unit 101 may record just part of a frame in any of memory areas A, B, and C. In Japanese terrestrial digital broadcasting, for example, the telop is usually displayed at the top of the picture, so the video recording unit 101 may record the video signal in a subarea 302 at the top of the full picture area 301 of a video frame, as shown in FIG. 3. The position of the recorded part of the frame may be fixed or variable. For example, past detection results obtained by the telop detector 102 may be used to determine which part of the current frame to record.

Referring again to FIG. 1, from the sequence of video frames input to the video processing device 100, the telop detector 102 detects telop areas including telops. Specifically, the telop detector 102 detects a telop area in the current video frame recorded by the video recording unit 101. More specifically, the telop detector 102 reads the current video frame from the video recording unit 101 and analyzes the frame to decide whether it includes a telop. In general the telop area may be an area of any shape, such as a rectangle, trapezoid, parallelogram, or ellipse, or may be the area made up of the pixels constituting the telop characters, but in the description that follows it will be assumed that the telop detector 102 detects a rectangular telop area. Upon detecting a telop area including a telop the telop detector 102 outputs corresponding area information, such as the corner coordinates of the rectangular area. If the telop detector 102 decides that the current video frame does not include a telop area, it outputs information indicating the absence of a telop, such as identically zero coordinates or no information at all. The telop detector 102 may use the telop detection algorithm disclosed by Sugano et al. in Japanese Patent Application Publication No. 2009-93472 or any other appropriate algorithm for detecting telop areas.

From the sequence of video frames input to the video processing device 100, the telop change detector 103 detects the initial appearance of a telop. That is, the telop change detector 103 detects the initial appearance of a telop in the current video frame recorded by the video recording unit 101. In one exemplary telop change detection method, the telop change detector 103 outputs information indicating the appearance of a telop when the telop detector 102 detects a telop in the current video frame after failing to detect a telop in the video frame immediately preceding the current video frame. In another exemplary method, the telop change detector 103 itself reads the current video frame and the video frame immediately preceding the current video frame from the video recording unit 101 and compares the two frames to detect the appearance of a telop. For example, the telop change detector 103 may detect the edges of the characters constituting the telop and the edges of their character borders and detect the appearance of a new telop on the basis of changes in the detected edges. This method will be described in more detail in a second embodiment, where it is used to detect telop cutovers.

From the sequence of video frames input to the video processing device 100, the telop change detector 103 may also detect the disappearance of a telop. For example, when the telop detector 102 does not detect a telop in the current video frame after detecting a telop in the immediately preceding video frame, the telop change detector 103 may output information indicating the disappearance of the telop.

The recording controller 104 controls the video recording unit 101 in accordance with the detection results obtained by the telop detector 102 and telop change detector 103.

Specifically, the recording controller 104 records a video frame preceding the appearance of a telop in the input sequence of video frames in accordance with the detection results obtained by the telop change detector 103. For example, when the telop change detector 103 detects the appearance of a telop in the current video frame, the recording controller 104 has the video recording unit 101 record the video frame immediately preceding the current video frame recorded in memory area B or C into memory area A as the video frame immediately preceding the appearance of the telop.

When the telop change detector 103 detects the disappearance of a telop in the current video frame or when the telop detector 102 detects the absence of a telop in the current video frame, the recording controller 104 may have the video recording unit 101 erase the video frame recorded in memory area A.

The recording controller 104 also controls the video recording unit 101 so as to record each video frame in the sequence of video frames input to the video processing device 100 alternately in memory areas B and C. Memory areas B and C serve alternately as a memory area for the current video frame and a memory area for the video frame immediately preceding the current video frame.

When the telop detector 102 detects a telop area in a video frame of the input sequence of video frames, the video processor 105 replaces the telop area with an image derived from the video frame preceding the appearance of the telop in the telop area. That is, the video processor 105 interpolates a substitute image into the telop area by using the video frame preceding the appearance of the telop. For example, the video processor 105 acquires or generates a substitute image with no telop from the video frame preceding the appearance of the telop, and replaces the telop area with the substitute image. The video processor 105 may acquire an image of the area corresponding to the telop area as the substitute image, or generate the substitute image by performing image processing on the image of the area corresponding to the telop area. The area corresponding to the telop area may be an area identical to the telop area or an area including an image similar to that of the telop area. In this embodiment, the video processor 105 replaces the telop area of the current video frame recorded in memory area B or C with an image derived from the video frame recorded in memory area A, and outputs a modified current video frame in which the telop area has been replaced by the image. For example, the video processor 105 may receive the area information denoting the telop area in the current video frame from the telop detector 102 and replace the video signal of this telop area in the current video frame with the video signal of the same area in the video frame recorded in memory area A, which is the video frame immediately preceding the appearance of the telop.

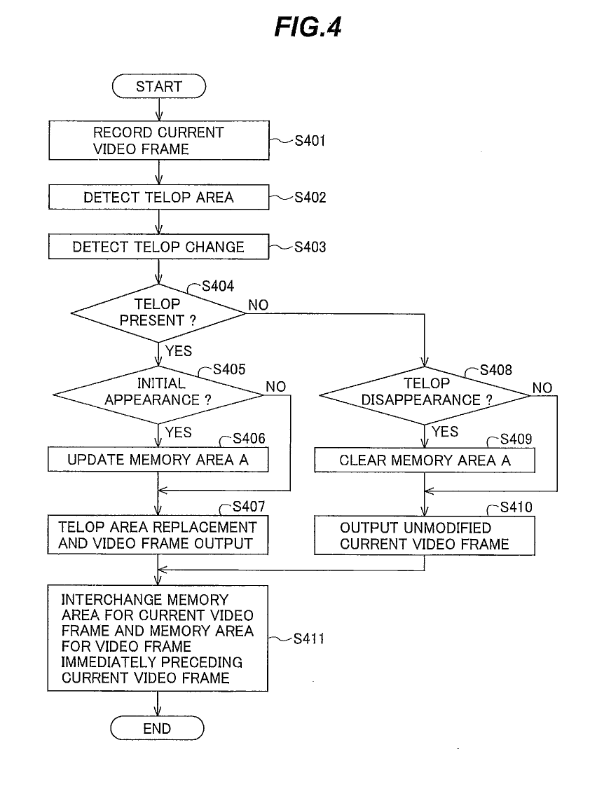

For each frame, the video processing device 100 in the first embodiment executes the process in the flowchart in FIG. 4. Step S401 is executed by the video recording unit 101, step S402 by the telop detector 102, step S403 by the telop change detector 103, steps S404, S405, S406, S408, S409, and S411 by the recording controller 104, and steps S407 and S410 by the video processor 105.

In the description of the decision steps S404, S405, and S408, for brevity, the expressions ‘if yes’ and ‘if no’ will be used to mean ‘if the decision is yes’ and ‘if the decision is no’.

In step S401, the input video frame or the input video signal of a single frame is recorded as the current video frame in the memory area B or C.

In step S402, the current video frame recorded in memory area B or C is examined to see whether it includes a telop area.

In step S403, the video processing device 100 decides whether there has been a telop change (the appearance or disappearance of a telop) between the current video frame and the immediately preceding video frame.

In step S404, the video processing device 100 decides whether a telop area has been detected in step S402. If yes, the process proceeds to step S405; if no, the process proceeds to step S408. Step S408 may be omitted, in which case the process proceeds to step S409. Alternatively, both steps S408 and 409 may be omitted, in which case the process proceeds to step S410.

In step S405, the video processing device 100 decides whether the appearance of the telop was detected in step S403. If yes, the process proceeds to step S406; if no, the process proceeds to step S407.

In step S406, the video frame immediately preceding the current video frame, which was recorded in memory area B or C in step S401 in the processing of the preceding frame and is still stored in that memory area, is recorded in memory area A as the video frame immediately preceding the appearance of the telop.

In step S407, the current video frame is read from memory area B or C; the image of the telop area detected in step S402 is replaced with the image derived from the video frame immediately preceding the appearance of the telop, which is stored in memory area A; a current video frame from which the telop has been erased is output; and the process proceeds to step S411.

In step S408, the video processing device 100 decides whether the disappearance of the telop was detected in step S403. If yes, the process proceeds to step S409; if no, the process proceeds to step S410.

In step S409, memory area A is cleared, and the process proceeds to step S410.

In step S410, the current video frame is read from memory area B or C and output, and the process proceeds to step S411.

In step S411 the roles of memory areas B and C are switched, the memory area for the current video frame now becoming the memory area for the video frame immediately preceding the current video frame, and the process ends.

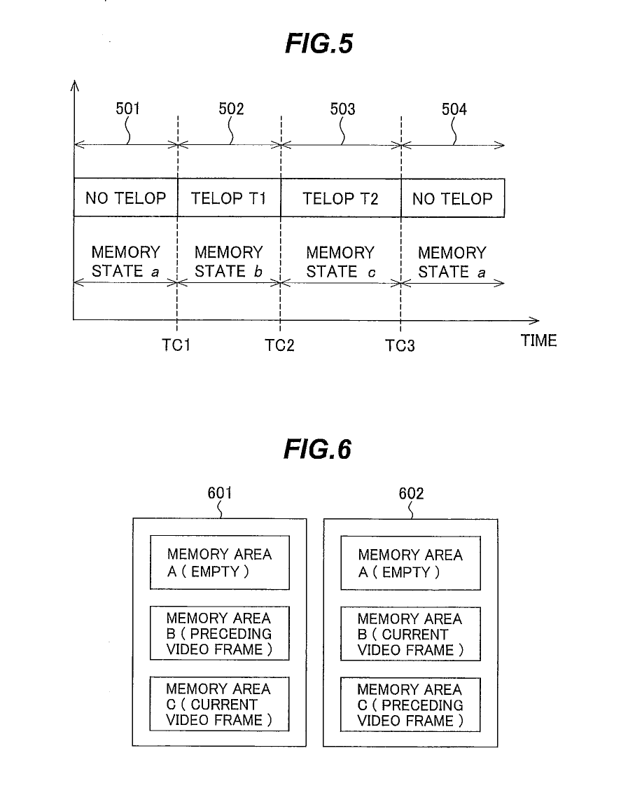

Next, the operation of the various components of the video processing device 100 will be described for the exemplary telop transitions and memory state transitions shown in FIG. 5.

In period 501, there is no telop. The telop detector 102 does not detect a telop, and the telop change detector 103 does not detect a telop change. The recording controller 104 repeatedly interchanges the memory area for the current video frame and the memory area for the video frame immediately preceding the current video frame, thereby storing the video frames alternately in memory areas B and C. The video recording unit 101 accordingly alternates once per frame between the states 601 and 602 shown in FIG. 6. Since there is no telop, memory area A is empty in both states 601 and 602. In state 601, memory area C holds the current video frame and memory area B holds the video frame immediately preceding the current video frame. In state 602, memory area B holds the current video frame and memory area C holds the video frame immediately preceding the current video frame. The video processor 105 outputs the current video frame without replacement.

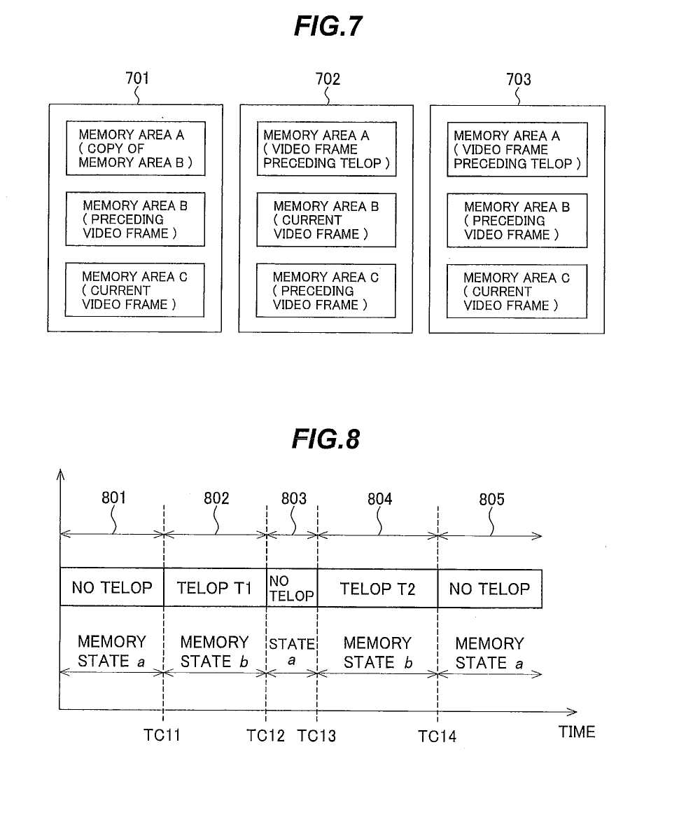

A telop change TC1 occurs at the transition from period 501 to period 502, and a telop T1 appears throughout period 502. The telop detector 102 first detects a telop area at the beginning (the first frame) of period 502, and the telop change detector 103 detects the initial appearance of telop T1 at this point. If the memory is in state 601 at the occurrence of telop change TC1, the recording controller 104 copies the video frame immediately preceding the current video frame from memory area B into memory area A, causing a transition from state 601 in FIG. 6 to state 701 in FIG. 7. In the remainder of period 502, the telop detector 102 continues to detect the telop area, but the telop change detector 103 does not detect a telop change. The recording controller 104 continues to switch the memory areas of the current video frame and the video frame immediately preceding the current video frame, thereby storing the input video frames alternately in memory areas B and C. The video recording unit 101 accordingly alternates between states 702 and 703 in FIG. 7. In state 702, memory area B holds the current video frame and memory area C holds the video frame immediately preceding the current video frame. In state 703, memory area C holds the current video frame and memory area B holds the video frame immediately preceding the current video frame. The video frame immediately preceding the appearance of telop T1 is left in memory area A. The video processor 105 replaces the telop area in the current video frame using the video frame in memory area A and outputs a modified current video frame from which telop T1 has been erased.

A telop change TC2 from telop T1 to a new telop T2 occurs at the transition from period 502 to period 503, but is not detected by the telop change detector 103 because a telop is continuously present. In the remainder of period 503, following telop change TC2, the telop detector 102 continues to detect a telop area and the telop change detector 103 continues not to detect a telop change. The recording controller 104 continues to store the input video frames alternately in memory areas B and C. The video recording unit 101 alternates between states 702 and 703 in FIG. 7 once per frame. Memory area A continues to hold the video frame immediately preceding the appearance of telop T1. The video processor 105 replaces the telop area in the current video frame using the video frame in memory area A and outputs a modified current video frame from which telop T2 has been erased.

A further telop change TC3 occurs at the transition from period 503 to period 504. Telop T2 disappears, and no new telop appears in period 504. In the first frame in period 504, the telop detector 102 fails to detect a telop and the telop change detector 103 detects the disappearance of the telop. The recording controller 104 clears memory area A, causing a transition from state 703 in FIG. 7 to state 601 in FIG. 6. In the remainder of period 504, the telop detector 102 continues not to detect a telop and the telop change detector 103 does not detect a telop change. The recording controller 104 continues to store the input video frames alternately in memory areas B and C, and the video recording unit 101 alternates between states 601 and 602 in FIG. 6. Memory area A remains empty. Throughout period 504, the video processor 105 outputs the current video frame without replacement.

Next, the operation of the video processing device 100 will be described for the exemplary telop transitions and memory state transitions shown in FIG. 8.

In period 801, there is no telop. The operations performed and the memory states of the video processing device 100 are the same as in period 501 in FIG. 5.

A telop change TC11 occurs at the transition from period 801 to period 802 and a telop T1 appears throughout period 802. The operations performed and the memory states in the video processing device 100 are the same as in period 502 in FIG. 5.

Another telop change TC12 occurs at the transition from period 802 to period 803. Telop T1 disappears and no telop appears in period 803. The operations performed and the memory states in the video processing device 100 are the same as in period 504 in FIG. 5.

Yet another telop change TC13 occurs at the transition from period 803 to period 804. A new telop T2 appears and is detected throughout period 804. The operations performed and the memory states of the video processing device 100 are the same as in period 502 in FIG. 5. The video processor 105 replaces the telop area in the current video frame using the video frame immediately preceding the appearance of telop T2, which is saved in memory area A, and outputs a modified current video frame from which telop T2 has been erased.

Still another telop change TC14 occurs at the transition from period 804 to period 805. Telop T2 disappears and no new telop appears in period 805. The operations performed and the memory states of the video processing device 100 are the same as in period 504 in FIG. 5.

The following effects (1) to (3) are obtained from the first embodiment.

(1) The video processing device in this embodiment replaces a telop area in a video frame with an image derived from the video frame preceding the appearance of the telop in the telop area. The telop area included in the video frame can therefore be replaced using only one type of video signal. Specifically, the telop area in the video frame can be replaced with a natural and appropriate substitute image derived from a video frame of the same type, and a good video frame from which the telop has been erased or which lacks the telop can be generated or displayed. Meanwhile, the above-described technique proposed by Murakoshi fails when no appropriate second video signal is available. Currently, this technique may fail even in Japan. Until the end of March 2008, Japanese broadcasters were required to air the same program content on both twelve-segment and one-segment broadcasts simultaneously, but this is no longer the case. Some twelve-segment broadcasts are now unaccompanied by a one-segment broadcast having the same content, so the necessary second video signal does not exist.

(2) The video processing device detects the appearance of a telop from the sequence of video frames and records the video frame preceding the appearance of the telop in the sequence of video frames. The video frame used for replacement of the telop area is therefore recorded selectively.

(3) The video processing device includes a video recording unit for receiving the sequence of input video frames in series and recording the current video frame and the preceding video frame, and detects a telop area and the appearance of a telop in the recorded current video frame. When the appearance of a telop is detected, the recorded video frame preceding the current video frame is recorded as the video frame preceding the appearance of the telop. When a telop area is detected in the current video frame, it is replaced with an image derived from the recorded video frame preceding the appearance of the telop, and a modified current video frame from which the telop has been erased is output. The input video frames can therefore be processed in their sequence.

### Second Embodiment

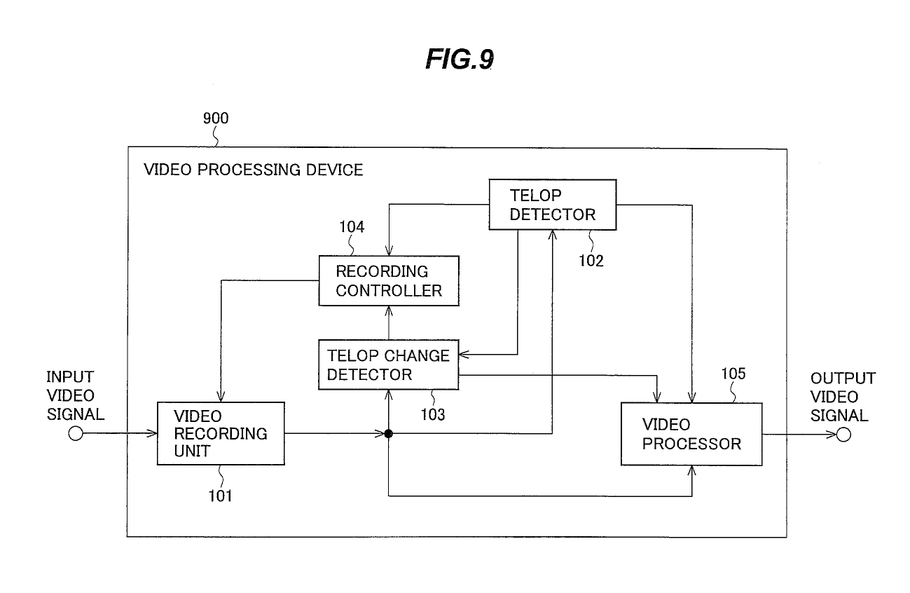

Referring to FIG. 9, the video processing device 900 in the second embodiment is substantially identical to the video processing device 100 in the first embodiment except that telop change detection includes cutover detection and the replacement method is switched according to the result of telop change detection. The description of the second embodiment will be confined to matters pertaining to these differences from the first embodiment.

The telop change detector 103 in the second embodiment detects both the initial appearance of a telop and a cutover from one telop to another telop. For example, it may detect edges of characters and character borders in the telop, and detect telop cutovers from changes in the detected edges. More specifically, it may detect edges of characters and character borders in the immediately preceding video frame and edges of characters and character borders in the current video frame and decide whether or not there has been a telop cutover according to whether the changes in edges between the two video frames exceed a predetermined level or not.

The telop change detector 103 may also detect the disappearance of a telop as a telop change. Telop appearance and disappearance may be detected on the basis of the detection of telop presence and absence by the telop detector 102.

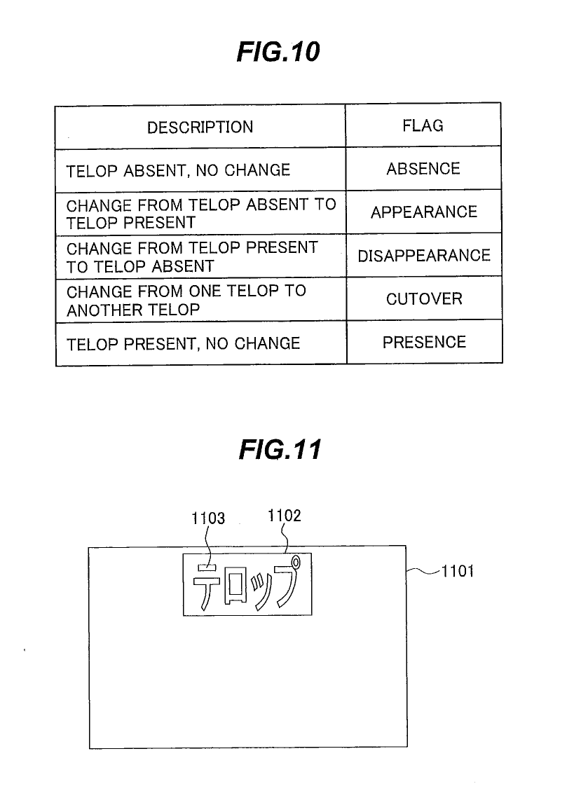

The telop change detector 103 outputs flags indicating the detected telop changes. FIG. 10 lists the flags that can be output by the telop change detector 103.

If the video frame immediately preceding the current video frame and the current video frame both fail to include telops, an absence flag, indicating that there is neither a telop nor a telop change, is output.

If the video frame immediately preceding the current video frame does not include a telop and the current video frame includes a telop, an appearance flag, indicating that a telop has just appeared, is output.

If the video frame immediately preceding the current video frame includes a telop and the current video signal does not include a telop, a disappearance flag, indicating that a telop has just disappeared, is output.

If both the video frame immediately preceding the current video frame and the current video frame include telops, whether the two telops are the same or not is determined. If there has been a cutover from one telop to another, that is, if a telop change has occurred, a cutover flag is output. If no such cutover has occurred, a presence flag is output, indicating the continued presence of an unchanged telop.

The cutover decision operation will be described for the exemplary telop shown in FIG. 11, which depicts the full picture area 1101 of a video frame, a telop area 1102 in the full picture area 1101, and a telop 1103 included in the telop area 1102.

The telop area 1102 is detected by the telop detector 102. For simplicity, it will be assumed that the pixels constituting the background of the telop area 1102, excluding the telop 1103, all have the same color value Kc.

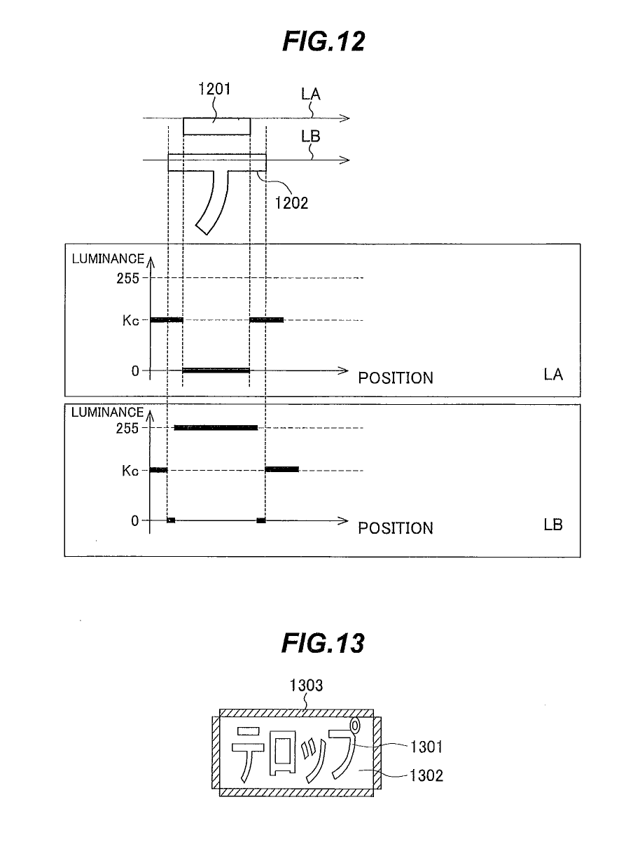

A telop generally includes characters 1201 having a certain character color and character borders 1202 having a certain border color, as shown in FIG. 12. The color values are expressed by eight-bit integers ranging from 0 to 255. A color value of zero (0) represents black, which is the border color here, and a color value of 255 represents white, which is the character color here. FIG. 12 shows the color distribution in a line LA passing through the top border of a character representing the Japanese syllable ‘te’ and the color distribution in a line LB passing through a middle part of this character.

Line LA has two color change points, where the color changes first from the background color with color value Kc to the border color with color value 0, then to the background color with color value Kc again. Line LB has four color change points: the color changes from the background color (Kc) to the border color (0) for just a few pixels, then to the character color (color value 255), then back to the border color (0) for another few pixels, and finally back to the background color (Kc).

To detect telop cutovers, the telop change detector 103 looks for such changes in the horizontal and vertical directions in an entire area or a telop area in the frame. A telop cutover alters the number of changes and their positions, so in one exemplary detection method, the telop change detector 103 detects telop cutovers from the number of detected changes or their positions. For example, the positions of the detected changes may be expressed as two-dimensional vectors referenced to an origin (0, 0) at the top left corner of the telop area 1102 in FIG. 11, and the telop change detector 103 may take the sum of the vector magnitudes and decide whether or not a telop change has occurred depending on the change in the magnitude of the sum. Alternatively, the telop change detector 103 may decide whether or not a telop change has occurred from the difference in the number of detected changes. Changes may be detected in just the horizontal direction or just the vertical direction instead of both directions.

In the telop change detection, when the absolute value d of the difference in color value between two adjacent pixels is not less than a predetermined threshold Kd (that is, when d≧Kd), the telop change detector 103 decides that there is a change in color value between the pixels. The telop change detector 103 may detect changes in color information as well as changes in color value. For example, pixels may be expressed as three-dimensional vectors based on a luminance signal Y and chrominance signals (Cb, Cr), and a change in color may be detected on the basis of the absolute value of the difference in the vector magnitudes between two adjacent pixels.

The above methods are exemplary. Any method that can detect a telop cutover between the current video frame and the immediately preceding video frame may be used.

In the methods described above, the telop change detector 103 uses the detection results produced by the telop detector 102 in detecting telop changes such as the appearance or disappearance of a telop or a cutover to a different telop, but the telop change detector 103 may detect telop changes by a different method. For example, the telop change detector 103 may read the current video frame and the immediately preceding video frame from the video recording unit 101 and compare the two frames to detect a telop change. In that case, the telop change detector 103 may detect the edges of the characters and character borders constituting the telop as described above, and then detect telop changes from changes in the edges. The telop change detector 103 may detect telop changes from the video signals of entire frames or from the video signals of the telop area detected by the telop detector 102.

The video processor 105 replaces the telop area detected in a video frame in accordance with the detection results obtained by the telop change detector 103. If the video frame in which the replacement is made is preceded by the appearance of a telop, the telop area is replaced with the substitute image derived from the video frame preceding the appearance of the telop in the telop area. If the video frame in which the replacement is made is preceded by a telop cutover, the telop area is replaced with the substitute image derived from pixels peripheral to the telop area in the video frame in which the replacement is made. That is, the video processor 105 interpolates a substitute image into the telop area by using the video frame preceding the appearance of the telop, if the last telop change preceding the video frame in which the interpolation is made is the initial appearance of the telop. The video processor 105 interpolates a substitute image into the telop area by using pixels peripheral to the telop area in the video frame in which the interpolation is made, if the last telop change preceding the video frame in which the interpolation is made is a telop cutover.

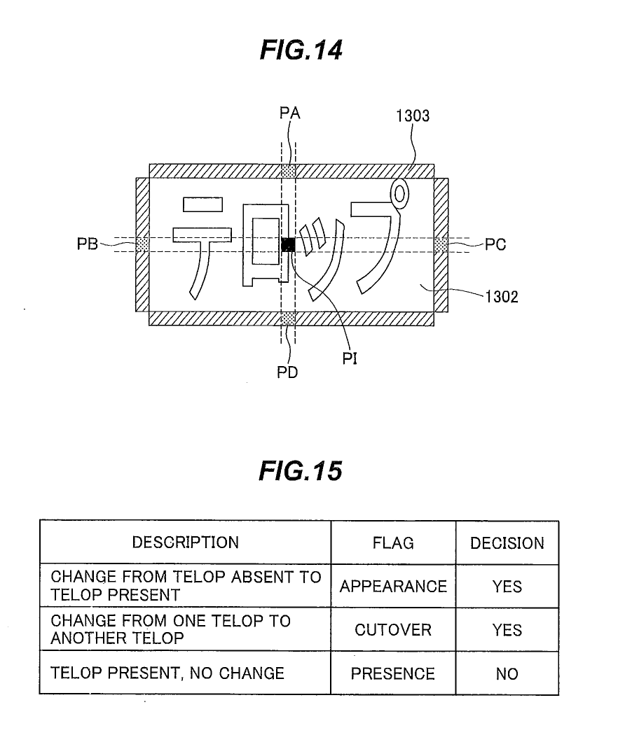

An exemplary method of replacing the telop area with the image from the peripheral pixels will be described next with reference to FIGS. 13 and 14. The telop 1301 shown in FIG. 13 is located in a telop area 1302 surrounded by a peripheral area 1303 consisting of pixels that are horizontally or vertically adjacent to the telop area 1302.

The video processor 105 replaces each pixel value in the telop area 1302 with a pixel value derived from pixels in the peripheral area 1303 outside the telop area 1302. For example, the video processor 105 obtains the substitute pixel value of pixel PI in FIG. 14 by averaging the pixel values of the four pixels PA, PB, PC, PD in the vertically and horizontally projected positions of pixel PI in the peripheral area 1303. If the pixel value is expressed in terms of its red, green, and blue (R, G, B) primary color components, the video processor 105 obtains the pixel value (R_{I}, G_{I}, B_{I}) of the replaced pixel PI by using the following equation (1) from the pixel value (R_{A}, G_{A}, B_{A}) of pixel PA, the pixel value (R_{B}, G_{B}, B_{B}) of pixel PB, the pixel value (R_{C}, G_{C}, B_{C}) of pixel PC, and the pixel value (R_{D}, G_{D}, B_{D}) of pixel PD. The pixel value of each primary color is expressed by, for example, an eight-bit integer ranging from 0 to 255.

$$( {R}_{I} , {G}_{I} , {B}_{I} ) = ( \frac{{R}_{A} + {R}_{B} + {R}_{C} + {R}_{D}}{4} , \frac{{G}_{A} + {G}_{B} + {G}_{C} + {G}_{D}}{4} , \frac{{B}_{A} + {B}_{B} + {B}_{C} + {B}_{D}}{4} ) \qquad ( 1 )$$

Alternatively, the video processor 105 may obtain the pixel value of the replaced pixel PI by averaging the pixel values of just the two pixels PB and PC in the horizontally projected positions in the peripheral area 1303, or just the two pixels PA and PD in the vertically projected positions.

The operation of the video processing device 900 in the second embodiment is substantially the same as the operation of the video processing device 100 in the first embodiment. The video processing device 900 executes the process in the flowchart in FIG. 4, with the following modifications.

In step S403 in the second embodiment, the video processing device 900 detects telop cutovers, as well as the appearance and disappearance of a telop, as telop changes.

In step S405, from the flag output by the telop change detector 103 in step S403, the video processing device 900 decides whether the appearance of a telop or a telop cutover was detected in step S403. If the appearance or cutover flag was output, the decision in step S405 is yes, as indicated in FIG. 15, and the process proceeds to step S406. If the presence flag was output, the decision in step S405 is no, and the process proceeds to step S407.

In step S407, the video processing device 900 replaces the telop area by a method determined from the last preceding telop change, as detected in step S403 in the processing of the current or a preceding frame. For example, if the last telop change preceding the current video frame was the appearance of a telop, the video processing device 900 replaces the telop area in the current video frame with a substitute image derived from the video frame immediately preceding the appearance of the telop, which is recorded in memory area A, as in the first embodiment. If the last telop change preceding the current video frame was a telop cutover, the telop area in the current video frame is replaced by a substitute image derived from pixels peripheral to the telop area in the current video frame.

The operation of the various components of the video processing device 900 will now be described for the exemplary telop transitions and memory state transitions shown in FIG. 5.

In period 501, the operation of the components of the video processing device 900 and the memory states are the same as for the video processing device 100 in the first embodiment. The video recording unit 101 alternates once per frame between the states 601 and 602 shown in FIG. 6, and memory area A is empty. This state of the video recording unit 101 will be referred to as memory state a.

At the beginning of period 502, the telop detector 102 detects a telop area. The telop change detector 103 detects the initial appearance of the telop and outputs the appearance flag. If the memory is in state 601 at the occurrence of telop change TC1, the recording controller 104 copies the video frame immediately preceding the current video frame from memory area B into memory area A, causing a change from state 601 in FIG. 6 to state 701 in FIG. 7. In the remainder of period 502, the telop detector 102 continues to detect the telop area, but the telop change detector 103 does not detect a telop change, so the presence flag is output. The video recording unit 101 alternates once per frame between states 702 and 703 in FIG. 7, and memory area A holds the video frame immediately preceding the appearance of telop T1. This state of the video recording unit 101 will be referred to as memory state b. In period 502, the video processor 105 replaces the telop area in the current video frame with a substitute image derived from the video frame in memory area A and outputs a modified current video frame from which the telop T1 has been erased.

At the beginning of period 503, the telop detector 102 detects a telop area, and the telop change detector 103 detects a telop cutover and outputs the cutover flag. In response to the cutover flag, the recording controller 104 copies the video frame immediately preceding the telop cutover from memory area B into memory area A. In the remainder of period 503, the telop detector 102 continues to detect a telop area but the telop change detector 103 does not detect a telop change and outputs the presence flag. The video recording unit 101 alternates between states 702 and 703 in FIG. 7 once per frame, and memory area A continues to hold the video frame immediately preceding the cutover to telop T2. This state of the video recording unit 101 will be referred to as memory state c. The video processor 105 replaces the telop area with a substitute image derived from pixels peripheral to the telop area in the current video frame and outputs a modified current video frame from which telop T2 has been erased.

At the beginning of period 504, the telop detector 102 fails to detect a telop. The telop change detector 103 detects the disappearance of the telop and outputs the disappearance flag, causing the recording controller 104 to clear memory area A. In the remainder of period 504, the telop detector 102 continues not to detect a telop. The telop change detector 103 does not detect a telop change and outputs the absence flag. The video recording unit 101 alternates between states 601 and 602 in FIG. 6, and memory area A remains empty. The video recording unit 101 is in memory state a in period 504. Throughout period 504, the video processor 105 outputs the current video frame without replacement.

The video processing device 900 may hold information indicating whether the video recording unit 101 is in memory state a, b, or c and determine the replacement method in accordance with this information. For example, if the video recording unit 101 is in memory state b in step S407 in FIG. 4, a substitute image may be derived from the video frame immediately preceding the appearance of the telop; if the video recording unit 101 is in memory state c in step S407, a substitute image may be derived from the pixels peripheral to the telop area.

For the exemplary telop transitions in FIG. 8, the memory states of the video processing device 900 and the operation of its components are the same as for the video processing device 100 in the first embodiment.

In addition to the effects (1) to (3) described earlier, the following effect (4) is obtained from the second embodiment.

(4) The video processing device in this embodiment detects both the appearance of a telop and a cutover to a new telop as a telop change. When telop area replacement is carried out, if the video frame in which the replacement is made is preceded by the appearance of a telop, the telop area is replaced with a substitute image derived from the video frame preceding the appearance of the telop. If the video frame in which the replacement is made is preceded by a telop cutover, the telop area is replaced with a substitute image derived from pixels peripheral to the telop area in the video frame in which the replacement is made. The telop replacement method is therefore switched according to the type of preceding telop change.

### Third Embodiment

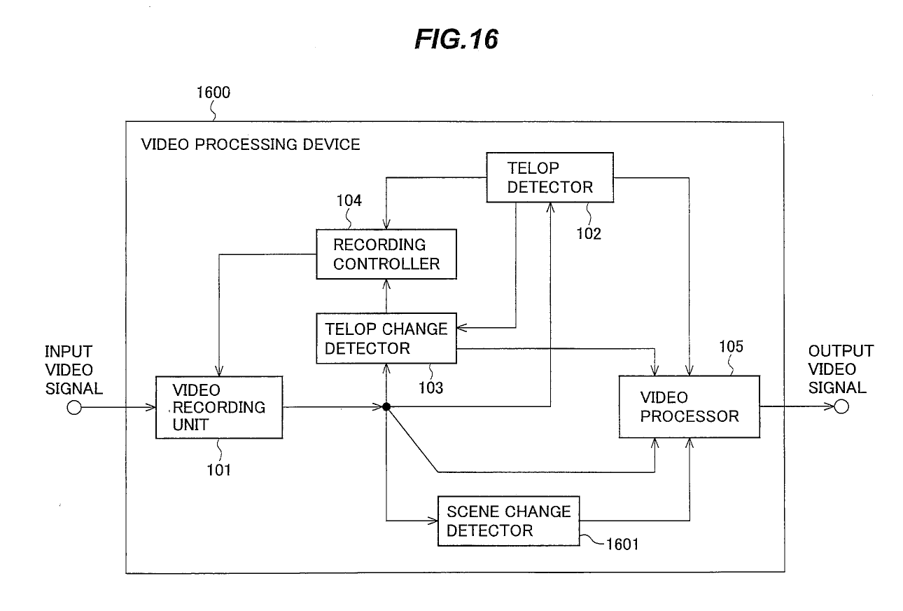

Referring to FIG. 16, the video processing device 1600 in the third embodiment is substantially identical to the video processing device 100 in the first embodiment except that the replacement method is switched according to the result of scene change detection. The description of the third embodiment will be confined to matters pertaining to this difference from the first embodiment.

As shown in FIG. 16, the video processing device 1600 has an additional scene change detector 1601 that detects scene changes in the input sequence of video frames. The video processing device 1600 may detect scene changes by, for example, reading the current video frame and the immediately preceding video frame from the video recording unit 101 and comparing them. Scene change detection is a well known art, so a detailed description will be omitted.

The video processor 105 replaces the telop area detected in a video frame in different ways according to the detection results obtained by the scene change detector 1601. If no scene change occurs between the video frame preceding the initial appearance of the telop in the telop area and the video frame in which the replacement is made, the telop area is replaced with the substitute image derived from the video frame preceding the appearance of the telop. If a scene change occurs between the two video frames, the telop area is replaced with the substitute image derived from the pixels peripheral to the telop area in the video frame in which the replacement is made. That is, the video processor 105 interpolates a substitute image into the telop area by using the video frame preceding the video frame in which the telop initially appears, if the scene change detector 1601 does not detect a scene change between the video frame preceding the video frame in which the telop initially appears and the video frame in which the interpolation is made. The video processor 105 interpolates a substitute image into the telop area by using pixels peripheral to the telop area in the video frame in which the interpolation is made, if the scene change detector 1601 detects a scene change between the video frame preceding the video frame in which the telop initially appears and the video frame in which the interpolation is made.

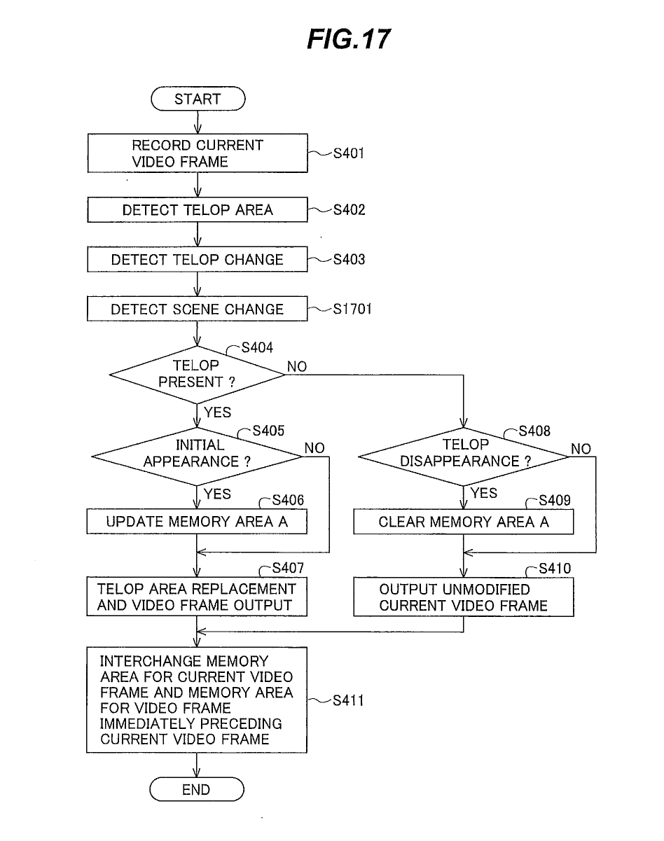

The video processing device 1600 in the third embodiment executes the process shown in the flowchart in FIG. 17.

In step S1701, preceding step S404, the video processing device 1600 checks for a scene change in the current video frame recorded in the memory area for the current video frame. Specifically, the video processing device 1600 decides whether a scene change has occurred between the current video frame and the immediately preceding video frame.

In step S407, the video processing device 1600 replaces the telop area, using an replacement method depending on the presence or absence of a scene change at or after the initial appearance of the telop, in accordance with the results of telop change detection in step S403 and of scene change detection in step S1701 in the processing of the current frame and the preceding frame. If no scene change has been detected in the processing of the frame in which the telop initially appeared or any subsequent frame, the video processing device 1600 replaces the telop area in the current video frame with a substitute image derived from the video frame immediately preceding the initial appearance of the telop, which is recorded in memory area A, as in the first embodiment. If a scene change has been detected in the processing of the frame in which the initial appearance of the telop was detected or in some subsequent frame, the telop area in the current video frame is replaced with a substitute image derived from the pixels peripheral to the telop area in the current video frame.

In addition to the effects (1) to (3) described earlier, the following effect (5) is obtained from the third embodiment.

(5) The video processing device in this embodiment detects scene changes in the input sequence of video frames. If no scene change has occurred between the video frame preceding the initial appearance of the telop and the video frame in which the replacement is made, the telop area is replaced with a substitute image derived from the video frame preceding the initial appearance of the telop. If a scene change has occurred between the two video frames, the telop area is replaced with a substitute image derived from the pixels peripheral to the telop area in the video frame in which the replacement is made. By deriving the substitute image in different ways depending on the presence or absence of a scene change, the third embodiment can prevent a telop area in a video frame from being replaced with a substitute image derived from a video frame in a different scene.

### Fourth Embodiment

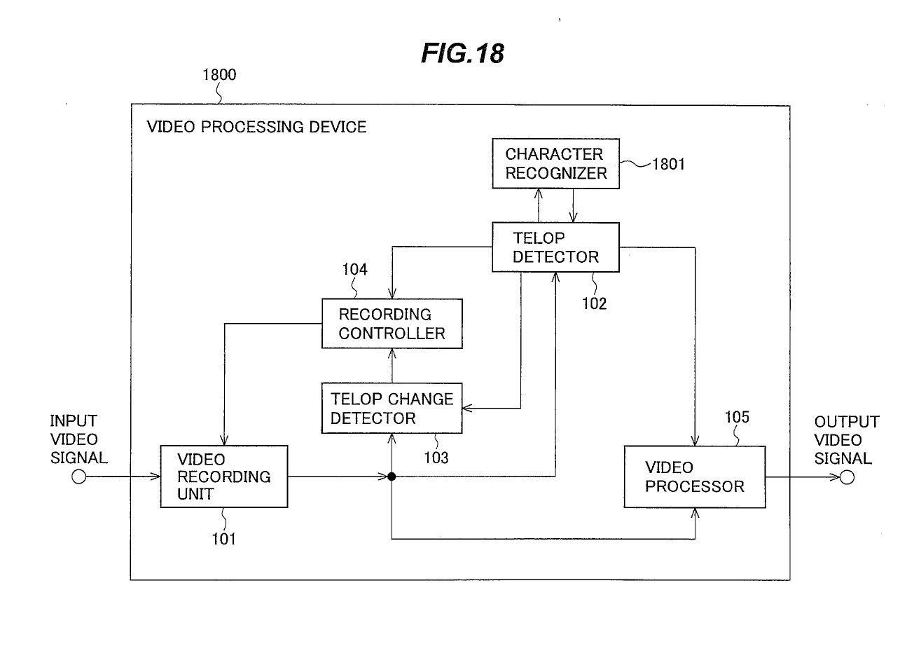

Referring to FIG. 18, the video processing device 1800 in the fourth embodiment is substantially identical to the video processing device 100 in the first embodiment except that character recognition is used to detect telop areas. The description of the fourth embodiment will be confined to matters pertaining to this difference from the first embodiment.

As shown in FIG. 18, the video processing device 1800 includes an additional character recognizer 1801 that performs character recognition on the video frames.

The telop detector 102 in this embodiment has the character recognizer 1801 perform character recognition on the video frames and detects, as telop areas, only areas found to include character information as a result of character recognition.

Specifically, the telop detector 102 reads the current video frame from the video recording unit 101 and detects a telop area in the current video frame as in the first embodiment. The telop detector 102 then sends its detection results, such as the area information defining the telop area, together with the current video frame to the character recognizer 1801.

The character recognizer 1801 receives the current video frame and detection results, performs image analysis on the telop area detected in the current video frame, and decides whether the telop area includes character information. If there is character information in the telop area, the character recognizer 1801 decides that the telop area includes a telop. If there is no character information in the telop area, the character recognizer 1801 decides that the telop area does not include a telop. The character recognizer 1801 sends the result of this decision to the telop detector 102.

The telop detector 102 accepts the decision made by the character recognizer 1801 and sends the telop change detector 103, recording controller 104, and video processor 105 the consequent result of telop area detection. Specifically, when the character recognizer 1801 decides that there is a telop, the telop detector 102 outputs the area information identifying the detected telop area; when the character recognizer 1801 decides that there is no telop, the telop detector 102 outputs information indicating that there is no telop.

Alternatively, when the character recognizer 1801 decides that a telop is present, it may send the detection result obtained by the telop detector 102 directly to the telop change detector 103, recording controller 104, and video processor 105, instead of sending the result of its own decision to the telop detector 102. When the character recognizer 1801 decides that no telop is present, it may send information indicating the absence of a telop directly to the telop change detector 103, recording controller 104, and video processor 105. In both cases, the output of the decision result from the character recognizer 1801 to the telop detector 102 and the output of the detection result from the telop detector 102 to the telop change detector 103, recording controller 104, and video processor 105 can be omitted.

In addition to the effects (1) to (3) described earlier, the following effect (6) is obtained from the fourth embodiment.

(6) The video processing device in this embodiment performs character recognition on the video frames and detects, as a telop area, an area found, as a result of character recognition, to include character information.

### Fifth Embodiment

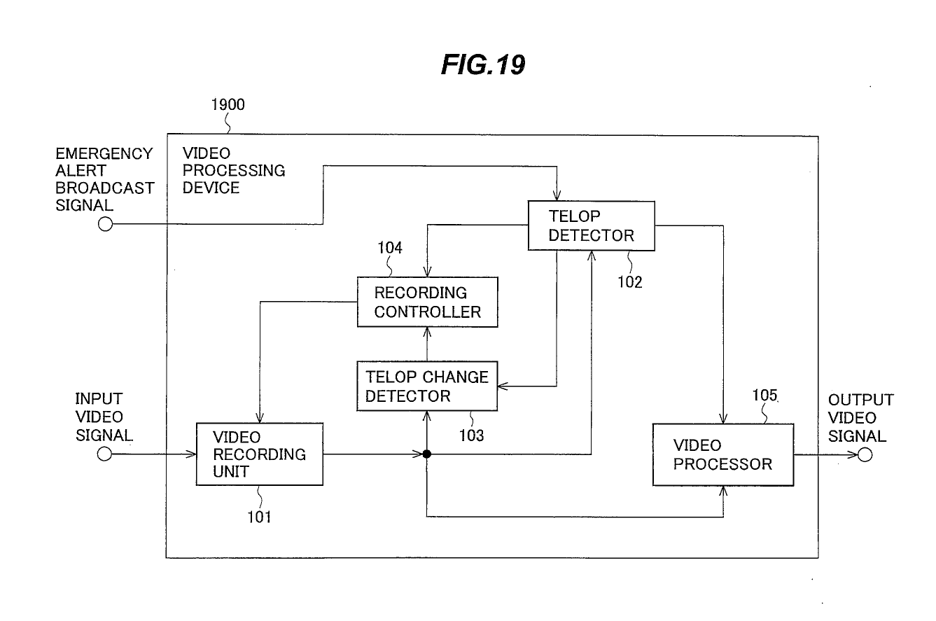

Referring to FIG. 19, the video processing device 1900 in the fifth embodiment is substantially identical to the video processing device 100 in the first embodiment except that replacement is enabled and disabled according to emergency alert broadcast signals. The description of the fifth embodiment will be confined to matters pertaining to this difference from the first embodiment.

When a natural calamity such as an earthquake occurs or when a tidal wave warning is issued, an emergency alert broadcast signal is broadcast to prevent or reduce damage caused by the calamity. Therefore, the telop displayed upon the emergency alert broadcast should not be erased in real-time viewing or listening.

The video processing device 1900 in this embodiment does not perform telop area replacement when it receives an emergency alert broadcast signal.

In the exemplary configuration shown in FIG. 19, emergency alert broadcast signals are input to the telop detector 102. When the telop detector 102 receives an emergency alert broadcast signal, even if it detects a telop area, it outputs a detection result indicating that it has not detected the telop area. Accordingly, when the emergency alert broadcast signal is input, the video processor 105 outputs the current video frame without performing telop area replacement, and the telop upon emergency alert broadcast is not erased.

When video signals are recorded by a video recorder, for example, it may be permissible to erase a telop upon emergency alert broadcast, because the information may not be needed when the recorded signals are viewed. For example, when the video processing device 1900 is used in a video recorder, the user may be allowed to enable or disable replacement for telops upon emergency alert broadcast. The video processing device 1900 may present the user with a mode option to enable or disable replacement for emergency alert telops. replacement can be enabled or disabled for emergency alert telops by enabling or blocking the input of the emergency alert broadcast signal to the telop detector 102, for example.

In addition to the effects (1) to (3) described earlier, the following effect (7) is obtained from the fifth embodiment.

(7) When the video processing device in this embodiment receives an emergency alert broadcast signal, it does not perform replacement of the telop area and can leave the emergency alert telop.

### Sixth Embodiment

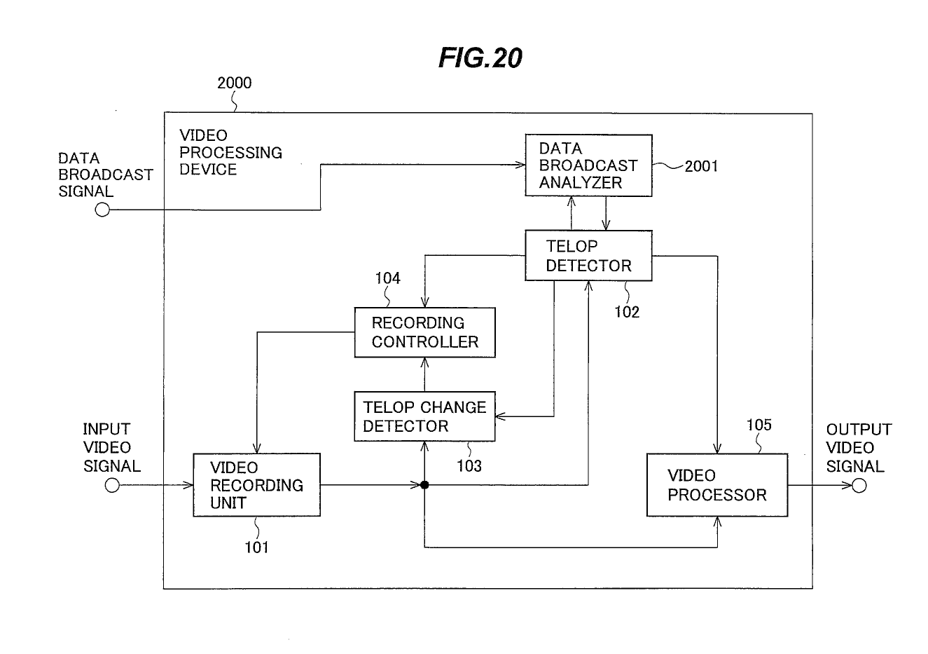

Referring to FIG. 20, the video processing device 2000 in the sixth embodiment is substantially identical to the video processing device 100 in the first embodiment except that replacement is enabled and disabled according to data broadcast signals. The description of the sixth embodiment will be confined to matters pertaining to this difference from the first embodiment.

When a data broadcast signal including emergency alert information is received, the video processing device 2000 in this embodiment does not perform telop area replacement.

As shown in FIG. 20, the video processing device 2000 has an additional data broadcast analyzer 2001 that receives and analyzes the data broadcast signal and, if the signal includes emergency alert information, sends a telop detection disable signal to the telop detector 102. If the data broadcast signal does not include emergency alert information, the data broadcast analyzer 2001 does not send the telop detection disable signal to the telop detector 102.

When the telop detector 102 receives a telop detection disable signal from the data broadcast analyzer 2001, even if it detects a telop area, it outputs a detection result indicating that it has not detected the telop area. Accordingly, when a data broadcast signal including emergency alert information is received, the video processor 105 outputs the current video frame without performing telop area replacement, and a telop upon emergency alert is not erased.

The video processing device 2000 may also disable replacement when the data broadcast signal includes certain information other than emergency alert information, such as a keyword or the name of a celebrity specified by the user.

In addition to the effects (1) to (3) described earlier, the following effect (8) is obtained from the sixth embodiment.

(8) When a data broadcast signal including certain information is received, in accordance with that information, the video processing device in this embodiment does not perform telop area replacement and refrains from erasing the telop.

### Seventh Embodiment

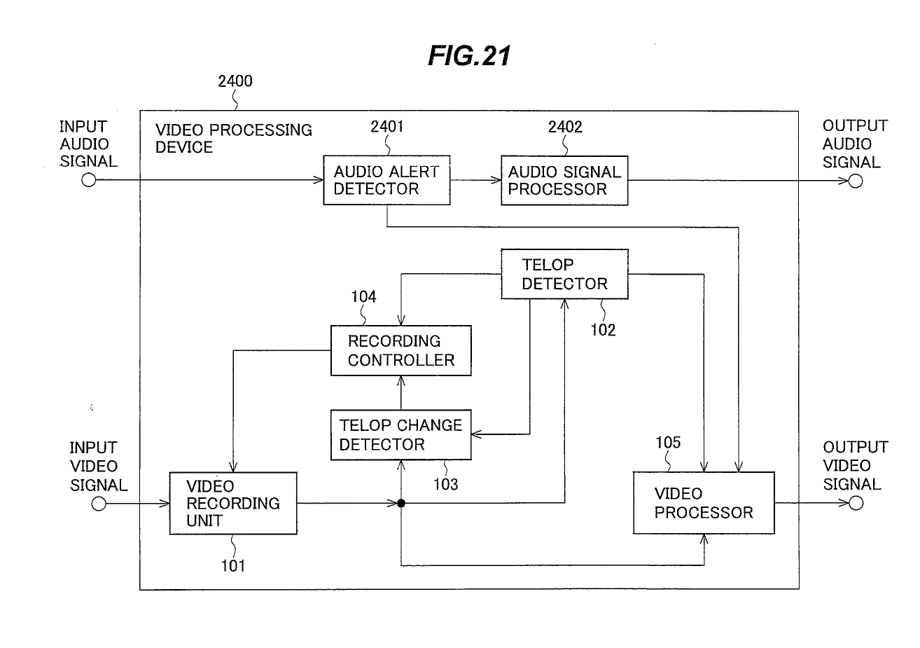

Referring to FIG. 21, the video processing device 2400 in the seventh embodiment is substantially identical to the video processing device 100 in the first embodiment except that replacement is carried out on the basis of the detection of audio alerts. The description of the seventh embodiment will be confined to matters pertaining to this difference from the first embodiment.

The video processing device 2400 in the seventh embodiment receives an input sequence of video signals and a corresponding input sequence of audio signals, detects audio alerts in the audio signals, detects telop areas including telops in the video signals, and replaces telop areas that are accompanied by audio alerts with substitute images. The input audio and video signals are, for example, high-definition television broadcast signals such as the twelve-segment signals broadcast in Japan. Audio alerts are audio signals superimposed on, inserted into, or combined with the main or original audio signal to draw attention to a telop. An audio alert may be, for example, a bell tone, chime tone, beep tone, or melody. The audio alert may occur before, during, or after the telop display. A telop accompanied by an audio alert may therefore occur, before, during, or after the audio alert. A telop accompanied by an audio alert will be referred to as an alert telop. An alert telop may indicate information such as an urgent earthquake report or a news flash.

The video processing device 2400 includes an audio alert detector 2401 and audio signal processor 2402 in addition to the video recording unit 101, telop detector 102, telop change detector 103, recording controller 104, and video processor 105 described in the preceding embodiments.

The audio alert detector 2401 receives an input sequence of audio signals corresponding to the input sequence of video frames, detects audio alerts in the audio signals, and informs the video processor 105 of its detection result. The audio alert detector 2401 may inform the video processor 105 as soon as it detects an audio alert, or it may provide the video processor 105 with information such as a time stamp or time indicating the timing at which the audio alert was detected and also indicating the timing of the occurrence of the audio alert in the input video signal. The audio alert detector 2401 can use any of various audio alert detection methods, including the method given in the January 2009 issue of Toranjisuta Gijutsu (Transistor Technology), in which the chime tone of an earthquake alert is detected from the successive appearance of the four frequencies (392, 415, 932, 988 Hz) characterizing the earthquake audio alert broadcast by Japan's national broadcasting network (NHK). Another method that may be used, disclosed in Japanese Patent Application Publication No. 2007-180669, models the modified discrete cosine transform (MDCT) coefficient vector of the input audio signal to decide whether it belongs to a particular sound class. By creating a sound model of an audio alert, this method can detect audio alerts with high accuracy. Audio alerts are loud because they have to draw the listener's attention, so in another possible method, the volume level of the input audio signal is monitored and an audio signal having a volume higher than a given level is considered an audio alert if it is accompanied by the detection of a telop. This method can detect alert telops accurately with a reduced audio alert detection processing load.

The video processor 105 selectively replaces the telop areas of telops accompanied by audio alerts detected by the audio alert detector 2401 with substitute images. In this embodiment, the video processor 105 selectively replaces the telop areas detected during a designated time period near the time at which an audio alert is detected. The designated time period should be determined appropriately from factors such as the usual temporal relationship between the audio alert and the related alert telop or telops. For example, the starting point of the time period with respect to the time of audio alert detection should be determined from the temporal relationship between the beginning of the audio alert and the beginning of the alert telop. The length of the time period should be determined from the length of time for which an alert telop is displayed, and a time period on the order of one to five minutes is contemplated. In the following description, a telop area detected within a designated time period following the detection of an audio alert is replaced. Accordingly, when the telop detector 102 detects a telop area in the current video frame within this time period following the detection of the audio alert, the video processor 105 replaces the telop area of the current video frame recorded in memory area B or C with a substitute image derived from the video frame immediately preceding the appearance of the telop, which is recorded in memory area A, and outputs a modified current video frame in which the telop area has been replaced with a substitute image. In one exemplary aspect of the seventh embodiment, the video processor 105 replaces only the telop areas of alert telops with substitute images. If a telop area is detected by the telop detector 102 outside the relevant time period, or if no audio alert is detected, the video processor 105 does not perform telop area replacement.

The audio signal processor 2402 reduces the volume level of the audio alert detected by the audio alert detector 2401 in the sequence of audio signals input to the video processing device 2400. Specifically, the audio signal processor 2402 reduces the volume level of the audio signal during the period in which the audio alert is detected by the audio alert detector 2401 so as to lower the volume level of the sound reproduced from the audio signal by, for example, three decibels (3 dB). During the period in which the audio alert is detected, the audio signal processor 2402 may reduce the volume level of the audio signal across the entire audio frequency band, or just at the characteristic frequency or frequencies of the audio alert. For example, the audio signal processor 2402 may incorporate an audio filter designed to attenuate a specific frequency or frequencies. The audio signal processor 2402 may also reduce the relative volume level of the audio alert by increasing the amplitude or volume level of sounds other than the audio alert.

The audio signal processor 2402 may delay the input audio signal to synchronize the sound of the input audio signal with the picture of the input video signal.

If it is unnecessary to correct the volume level or frequency characteristics of the audio alert or delay the audio alert, the audio signal processor 2402 may be omitted.

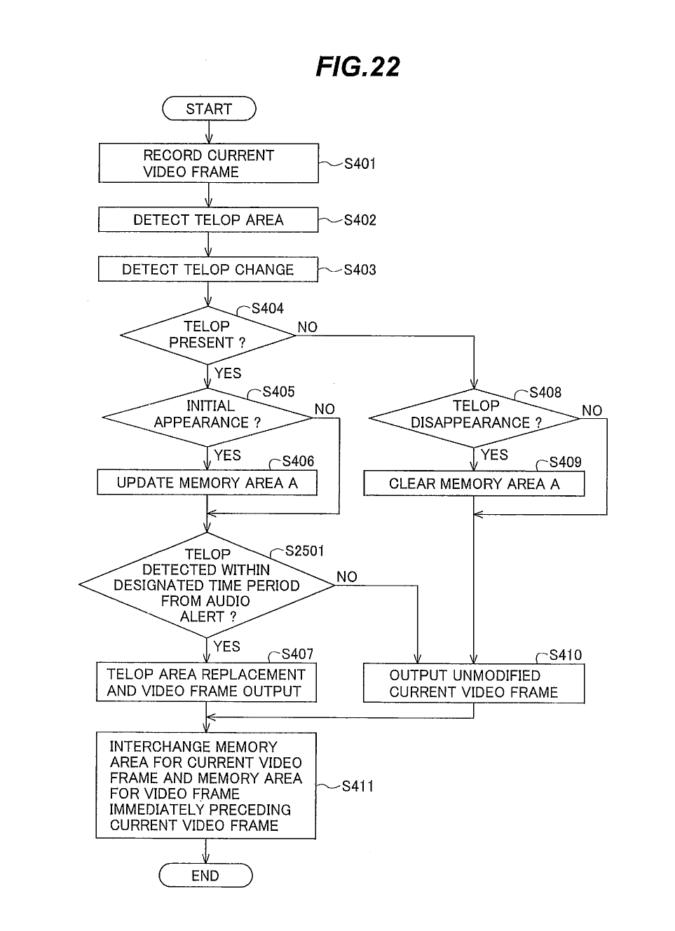

For each frame, the video processing device 2400 in the seventh embodiment executes the process in the flowchart in FIG. 22.

The process illustrated in FIG. 22 includes the steps S401 to S411 shown in FIG. 4 and an additional step S2501. If the appearance of a telop is not detected in step S405 in FIG. 22, the process proceeds to step S2501 instead of step S407. If the appearance of the telop is detected in step S405, the process proceeds to step S406 and then to step S2501. Step S2501 is executed by, for example, the video processor 105.

In step S2501, the video processing device 2400 decides whether the current time (or the time at which the telop area is detected) is within the designated time period following the detection of an audio alert by the audio alert detector 2401. If yes, the process proceeds to step S407 to perform telop area replacement. If no, the process proceeds to step S410 to output the current video frame without performing telop area replacement.

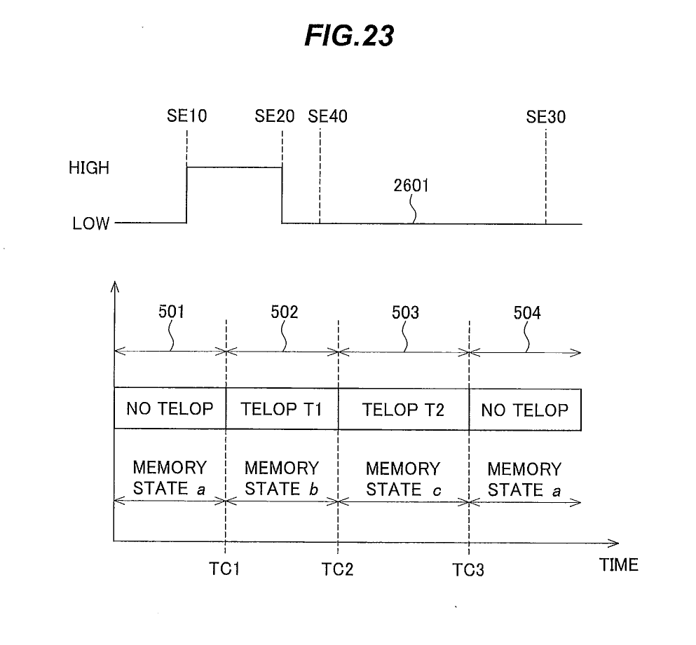

Telop area replacement will now be described for the exemplary telop transitions and audio alert detection result 2601 shown in FIG. 23. The telop transitions and memory state transitions are the same as in FIG. 5. The audio alert detection result 2601 is, for example, the output signal of the audio alert detector 2401. This signal is high when the audio alert detector 2401 detects an audio alert, and low when no audio alert is detected. The audio alert may be intermittent, but the audio alert detector 2401 regards an intermittent audio alert as being continuously present and holds the audio alert detection signal high even during the silent intervals. In FIG. 23, an audio alert occurs at time SE10 and vanishes at time SE20. The video processor 105 is informed of the detection of the audio alert at time SE10. The designated time period following the detection of the audio alert is the period from time SE10 to time SE30.

In period 502, the telop area of telop T1 is detected. In period 503, the telop area of another telop T2 is detected. Because these two telop areas are detected within the designated time period following the detection of the audio alert, the video processor 105 performs replacement for both telop areas.

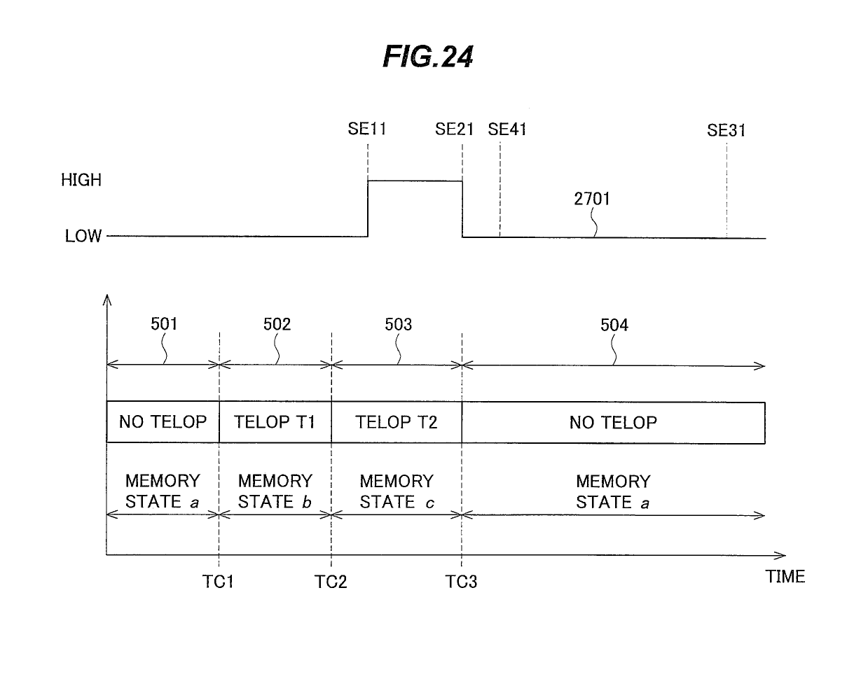

Telop area replacement will next be described for the exemplary telop transitions and audio alert detection result 2701 shown in FIG. 24. The telop transitions and memory state transitions are again the same as in FIG. 5. In FIG. 24, the audio alert occurs at time SE11 after telop change TC2, and vanishes at time SE21. The video processor 105 is informed of the detection of the audio alert at time SE11. The designated time period following the detection of the audio alert is the period from time SE11 to time SE31.

In period 502, the telop area of telop T1 is detected. Because the telop area is not detected within the designated time period following the detection of the audio alert, the video processor 105 does not replace the telop area.

In period 503, the telop area of telop T2 appears before time SE11. Up until time SE11 in period 503, since the telop area is not detected within the designated time period following the detection of the audio alert, the video processor 105 does not replace the telop area. After time SE11 in period 503, the telop area is detected within the designated time period following the detection of the audio alert, so the video processor 105 replaces the telop area.

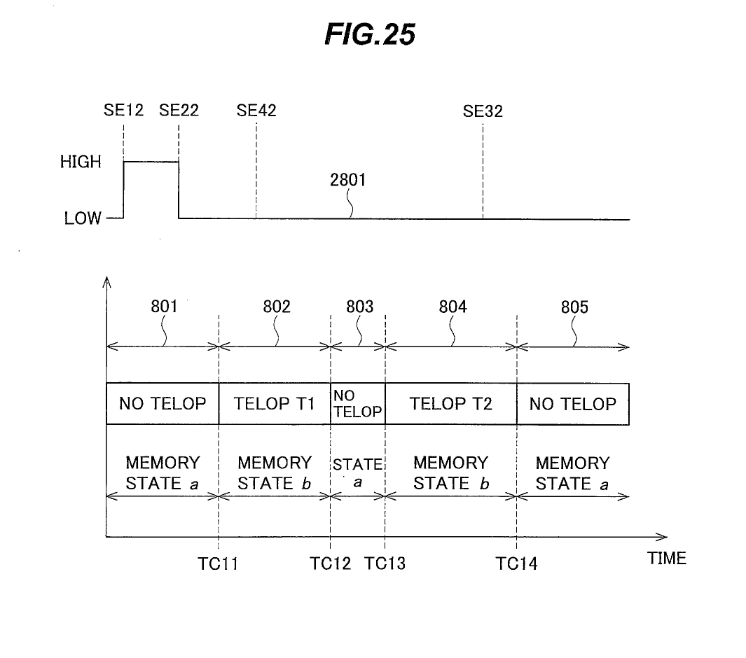

Telop area replacement will now be described for the exemplary telop transitions and audio alert detection result 2801 shown in FIG. 25. The telop transitions and memory state transitions are the same as in FIG. 8. In FIG. 25, the audio alert occurs at time SE12 and vanishes at time SE22, before telop change TC11. The video processor 105 is informed of the detection of the audio alert at time SE12. The designated time period following the detection of the audio alert is the period from time SE12 to time SE32.

In period 802, the telop area of telop T1 is detected. Because the telop area is detected within the designated time period following the detection of the audio alert, the video processor 105 replaces the telop area.

In period 804, the telop area of telop T2 appears before time SE32. Up until time SE32 in period 804, since the telop area is detected within the designated time period following the detection of the audio alert, the video processor 105 replaces the telop area. After time SE32 in period 804, since the telop area is not detected within the designated time period, the video processor 105 does not replace the telop area.

In addition to the effects (1) to (3) described earlier, the following effects (9) to (11) are obtained from the seventh embodiment.

(9) The video processing device in this embodiment detects an audio alert in the input sequence of audio signals and selectively replaces the telop area of a telop accompanied by the audio alert. Telops accompanied by the audio alert can be selectively erased, and telops that is not accompanied by an audio alert can be left intact. For example, alert telops such as information concerning an impending natural calamity, a security emergency, or some other urgent event not relevant to the original picture can be selectively erased by replacement, and telops related to the original picture can be left.

(10) The video processing device detects an audio alert in the input sequence of audio signals and selectively replaces the telop area detected during a designated time period near the time at which the audio alert is detected. With this method, an alert telop can be detected and selectively erased.

(11) The video processing device reduces the volume level of an audio alert detected in the input sequence of audio signals. This method can make the audio alert less obtrusive.

### Eighth Embodiment

The video processing device in the eighth embodiment has substantially the same structure as the video processing device in the seventh embodiment, shown in FIG. 21. The description of the eighth embodiment will be confined to differences from the seventh embodiment.

The telop change detector 103 in this embodiment informs the video processor 105 of the result of telop change detection. When it detects the initial appearance of a telop, the telop change detector 103 may immediately inform the video processor 105 of the detection of the appearance of the telop, or it may supply the video processor 105 with information such as a time or time stamp indicating the timing at which the appearance of the telop was detected. The telop change detector 103 may also inform the video processor 105 of the disappearance of the telop, either by reporting the disappearance immediately or by supplying information such as a time or time stamp indicating the timing at which the disappearance of the telop was detected.

If the appearance of a telop is detected within a first time period near the time at which an audio alert is detected by the audio alert detector 2401, the video processor 105 selectively replaces any telop area detected in a second time period near the time of audio alert detection. The first and second time periods should be determined appropriately from factors such as the usual temporal relationship between the audio alert and the related alert telop or telops. For example, the starting point of each of the two time periods with respect to the time of audio alert detection should be determined from the temporal relationship between the beginning of the audio alert and the beginning of the alert telop. Also, the length of the first time period should be determined from the above relationship between the beginnings. The length of the second time period should be determined from the length of time for which an alert telop is displayed. The first and second time periods may be the same, but in general, the second time period should be longer than the first time period. In the following description, when the appearance of the telop is detected within a designated time period TP1 after the detection of the audio alert, the video processor 105 selectively replaces any telop area detected within a designated time period TP2 after the detection of the audio alert. For example, when a telop appears within five seconds after the detection of an audio alert, the video processor 105 may decide that an alert telop has appeared, and may then selectively replace any telop area detected within three minutes from the detection of the audio alert, on the assumption that any such telop area may include an alert telop. In one aspect of this embodiment, the video processor 105 replaces only the telop areas of alert telops, leaving other telop areas intact.

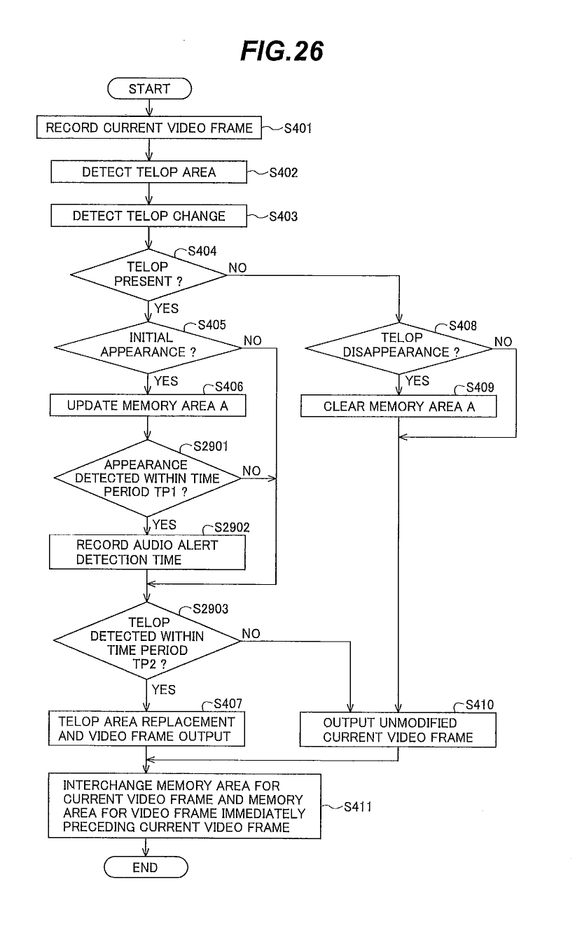

For each frame, the video processing device 2400 in the eighth embodiment executes the process in the flowchart in FIG. 26.

The process illustrated in FIG. 26 includes steps S2901 to S2903 in addition to steps S401 to S411 in FIG. 4. Steps S2901 to S2903 are executed by, for example, the video processor 105.

If the appearance of a telop is not detected in step S405, the process proceeds to step S2903 instead of step S407. If the appearance of a telop is detected in step S405, the process proceeds to step S406 then to step S2901 instead of step S407.

In step S2901, the video processing device 2400 decides whether the current time (or the time at which the telop appeared) is within the first time period TP1 from the time of the latest detection of the audio alert. If yes, the time of the latest detection of the audio alert is recorded in a given memory area as the time of detection of the audio alert corresponding to the alert telop (step S2902), and the process proceeds to step S2903. If no, step S2902 is skipped and the process proceeds to step S2903.

In step S2903, the video processing device 2400 decides whether the current time (or the time at which the telop area was detected) is within the second time period TP2 from the time of detection of the audio alert recorded in the memory area. If yes, telop area replacement is performed (step S407). If no, the current video frame is output without performing telop area replacement (step S410).

Telop area replacement will now be described for the exemplary telop transitions and audio alert detection result shown in FIG. 23. The first time period TP1 after the detection of the audio alert is the period from time SE10 to time SE40; the second time period TP2 after the detection of the audio alert is the period from time SE10 to time SE30.

In period 502, the telop area of telop T1 is detected. The appearance of the telop (telop change TC1) is detected at the beginning (first frame) of period 502. Since the telop appears within the first time period TP1, it is recognized as an alert telop, and time SE10 is recorded in the memory area. Since the telop area is detected within the second time period TP2 after the time SE10 recorded in the memory area, the video processor 105 replaces the telop area.

In period 503, the telop area of telop T2 is detected. Since this telop area is detected within the second time period TP2 after the detection time SE10 recorded in the memory area, telop T2 is also treated as an alert telop and the video processor 105 replaces the telop area.

Telop area replacement will next be described for the exemplary telop transitions and audio alert detection result shown in FIG. 24. The first time period TP1 after the detection of the audio alert is the period from time SE11 to time SE41.

In period 502, the telop area of telop T1 is detected but no audio alert is detected and no alert detection time is recorded in the memory area, so the video processor 105 does not replace the telop area.

In period 503, the telop area of telop T2 is detected, but since the initial appearance of telop T2 (telop change TC1) occurs at the beginning (first frame) of period 502, before time SE11 and not within the first time period TP1 following the detection of the audio alert at time SE11, telop T2 is not recognized as an alert telop. Accordingly, no alert detection time is recorded in the memory area, and even after time SE11 in period 503, the video processor 105 does not replace the telop area of telop T2.

Telop area replacement will now be described for the exemplary telop transitions and audio alert detection result shown in FIG. 25. The first time period TP1 after the detection of the audio alert is the period from time SE12 to time SE42. The second time period TP2 after the detection of the audio alert is the period from time SE12 to time SE32.

In period 802, the telop area of telop T1 is detected. The appearance of the telop (telop change TC11) is detected at the beginning (first frame) of period 802, within the first time period TP1 after the time SE12 at which the audio alert is detected, so telop T1 is recognized as an alert telop and time SE12 is recorded in the memory area. Since the telop area is detected within the second time period TP2 after the detection time SE12 recorded in the memory area, the video processor 105 replaces the telop area.

In period 804, the telop area of telop T2 is detected. Up until time SE32 in period 804, the telop area is detected within the second time period TP2 from the recorded time SE12 of audio alert detection, so the video processor 105 replaces the telop area of telop T2. After time SE32, the telop area is not detected within the second time period TP2 from the recorded time SE12 of audio alert detection, so telop T2 is no longer considered to be an alert telop and the video processor 105 does not replace the telop area.

The video processing device in the eighth embodiment detects audio alerts in the input sequence of audio signals. When the appearance of a telop is detected within a first time period near the time of audio alert detection, the video processing device selectively replaces any telop area detected in a second time period near the time of audio alert detection. The eighth embodiment thereby selectively erases telops considered to be alert telops.

### Ninth Embodiment

The video processing device in the ninth embodiment has substantially the same structure as the video processing device in the seventh embodiment, shown in FIG. 21. The description of the ninth embodiment will be confined to differences from the seventh embodiment.

The telop change detector 103 informs the video processor 105 of its detection results as in the eighth embodiment.

When the appearance of a telop is detected within a designated time period near the time at which an audio alert is detected by the audio alert detector 2401, the video processor 105 selectively replaces any telop areas including the detected telop. The designated time period should be determined appropriately from factors such as the usual temporal relationship between the audio alert and the related alert telop. For example, the starting point of the time period with respect to the time of audio alert detection and the length of the time period should be determined from the temporal relationship between the beginning of the audio alert and the beginning of the alert telop. In the description below, when the appearance of the telop is detected within a given time period after the audio alert has been detected, the video processor 105 selectively replaces any telop areas in the video frames that include the detected telop, starting from the time of appearance of the detected telop. For example, the video processor 105 may decide that an alert telop has appeared when the appearance of a telop is detected within five seconds from the detection of an audio alert, and then replaces any telop areas including telops identical to the detected alert telop. In one exemplary aspect of this embodiment, the video processor 105 replaces only telop areas including the detected alert telop, leaving other telop areas intact.

Alternatively, when the appearance of a telop is detected within a designated time period near the time at which an audio alert has been detected, the video processor 105 may replace any telop areas including the telop whose appearance was detected within this time period and any telop areas including telops recognizable as continuations of the telop whose appearance was detected. For example, following the appearance of a title telop such as ‘News Flash’ or ‘Earthquake Information’, a telop giving a news headline or earthquake data could be recognized as a continuation of the detected title telop.

The video processor 105 can decide whether a telop area includes the same telop as the one that appeared earlier or a telop that is a continuation of one that appeared earlier from the content and position of the telop.

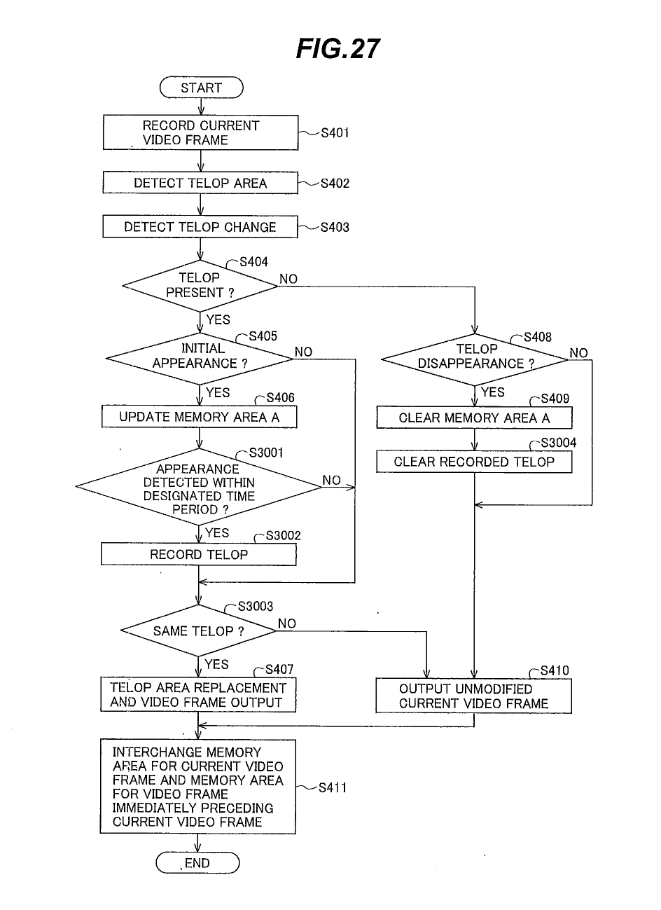

For each frame, the video processing device 2400 in the ninth embodiment executes the process in the flowchart in FIG. 27.

The process illustrated in FIG. 27 includes steps S3001 to S3004 in addition to steps S401 to S411 in FIG. 4. Steps S3001 to S3004 are executed by, for example, the video processor 105.

When the appearance of a telop is not detected in step S405, the process proceeds to step S3003 instead of step S407; when the appearance of a telop is detected, the process proceeds to step S406 and then to step S3001. After step S409, the process proceeds to step S3004 instead of step S410.

In step S3001, the video processing device 2400 decides whether the current time (or the time at which the telop appeared) is within a designated time period from the time at which the latest audio alert was detected. If yes, the process proceeds to step S3002. If no, the process proceeds to step S3003.

In step S3002, the video processing device 2400 records information that can be used to identify the telop that appears in the telop area detected in step S402 in a telop memory area. The information recorded in the telop memory area may be the video signal in the telop area, characteristic data obtained from the video signal, a character string included in the telop area, or other such information. The processing then proceeds to step S3003.

In step S3003, the video processing device 2400 decides whether the telop in the telop area detected in step S402 is the same as the telop recorded in the telop memory area. If yes, the process proceeds to step S407 to perform telop area replacement. If no, the process proceeds to step S410 to output the current video frame without performing telop area replacement.

Alternatively, in step S3003, the video processing device 2400 may decide whether the telop in the telop area detected in step S402 is identical to the telop recorded in the telop memory area or is a continuation of the telop recorded in the telop memory area, and proceed to step S407 to perform telop area replacement if the answer to either of these questions is yes.

In step S3004, the video processing device 2400 clears the telop memory area and proceeds to step S410.

Telop area replacement will now be described for the exemplary telop transitions and audio alert detection result shown in FIG. 23. The designated time period following the detection of the audio alert is the period from time SE10 to time SE40. The telop memory area is assumed to be initially empty.

In period 502, the telop area of telop T1 is detected. The appearance of telop T1 (telop change TC1) is detected at the beginning (first frame) of period 502. Since the appearance of telop T1 is detected within the designated time period, telop T1 is recognized as an alert telop and recorded in the telop memory area. Since the telop area detected in period 502 includes the telop recorded in the telop memory area, the video processor 105 replaces this telop area.

In period 503, the telop area of telop T2 is detected. Since this telop area does not include the same telop as the telop T1 recorded in the telop memory area, the video processor 105 does not perform telop area replacement. Alternatively, the video processor 105 may replace the telop area in period 503 if telop T2 is decided to be a continuation of the telop T1 recorded in the telop memory area.

At the beginning (first frame) of period 504, the disappearance of telop T2 (telop change TC3) is detected, and the telop memory area is cleared.

Telop area replacement will next be described for the exemplary telop transitions and audio alert detection result shown in FIG. 24. The designated time period following the detection of the audio alert is the period from time SE11 to time SE41. The telop memory area is assumed to be initially empty.

In period 502, the telop area of telop T1 is detected. The appearance of telop T1 (telop change TC1) is detected at the beginning (first frame) of period 502. Since the appearance of telop T1 is not detected within the designated time period, telop T1 is not recognized as an alert telop. Since the telop memory area is empty, the detected telop area does not include the same telop as the telop recorded in the telop memory area, so the video processor 105 does not perform telop area replacement.

In period 503, the telop area of telop T2 is detected. Since the telop memory area is empty, the telop area does not include the same telop as the telop recorded in the telop memory area, so the video processor 105 does not perform telop area replacement.

Telop area replacement will now be described for the exemplary telop transitions and audio alert shown in FIG. 25. The designated time period following the detection of the audio alert is the period from time SE12 to time SE42. The telop memory area is assumed to be initially empty.

In period 802, the telop area of telop T1 is detected. The appearance of telop T1 (telop change TC11) is detected at the beginning (first frame) of period 802. Since telop T1 appears within the designated time period, telop T1 is recognized as an alert telop and is recorded in the telop memory area. It is then decided that the telop area detected in period 802 includes the same telop as the telop T1 recorded in the telop memory area, and the video processor 105 replaces the telop area.

In period 803, there is no telop. The disappearance of the telop (telop change TC12) is detected at the boundary between period 802 and period 803, and the telop memory area is cleared.

In period 804, the telop area of telop T2 is detected. The appearance of telop T2 (telop change TC13) is detected at the beginning (first frame) of period 804. Since telop T2 does not appear within the designated time period, it is not recognized as an alert telop. The telop memory area is empty, so telop T2 is not recognized as the telop recorded in the telop memory area. The video processor 105 does not replace the telop area.

In the description given above, when the disappearance of the telop is detected, the telop memory area is cleared Immediately. In a variation of this embodiment, the telop memory area is cleared after the absence of the telop has continued for a given length of time. In that case, if period 803 in FIG. 25 is shorter than the given length of time, the telop memory area is not cleared. The video processor 105 may replace the telop area detected in period 804 if telop T2 is recognized as a continuation of the telop T1 recorded in the telop memory area.

The video processing device in this embodiment detects an audio alert in the input sequence of audio signals. If the appearance of a telop is detected within a designated time period near the time of audio alert detection, any telop area including the detected telop is selectively replaced. In this way, telops accompanying an audio alert can be selectively erased.

### Tenth Embodiment

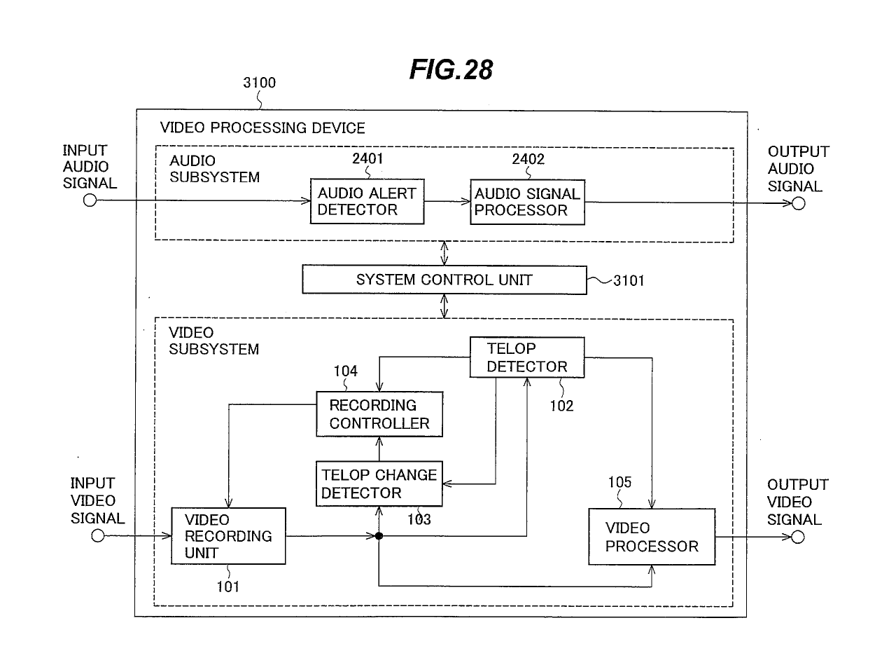

Referring to FIG. 28, the video processing device 3100 in the tenth embodiment is substantially identical to the video processing device 2400 in the seventh embodiment except that it has an additional system control unit 3101. The description of the tenth embodiment will be confined to matters pertaining to this difference from the seventh embodiment.

The system control unit 3101 controls the functions of the audio and video subsystems of the video processing device 3100 and is configured as, for example, a digital signal processor (DSP) or microprocessor. The recording controller 104 is shown as part of the video subsystem, but the recording controller 104 may be incorporated into the system control unit 3101 instead. In a variation of the tenth embodiment, the system control unit 3101 is external to the video processing device 3100.

The audio alert detector 2401 in this embodiment informs the system control unit 3101 of its detection results. The audio alert detector 2401 may inform the system control unit 3101 as soon as it detects an audio alert, or it may provide the system control unit 3101 with information such as a time stamp or time indicating the timing at which the audio alert was detected and also indicating the timing of the occurrence of the audio alert in the input video signal. The telop detector 102 also reports its detection results to the system control unit 3101.

The system control unit 3101 controls the video processor 105 in accordance with the detection results received from the audio alert detector 2401 and telop detector 102 so that the video processor 105 performs replacement selectively on telop areas detected within a designated time period from the time at which an audio alert is detected. When the audio alert detector 2401 reports detection of an audio alert, the system control unit 3101 starts measuring the lapse of time from when the audio alert was detected, using a timer or the like. When the telop detector 102 reports detection of a telop area, the system control unit 3101 decides whether the telop area was detected within the designated time period, as measured by the timer. If yes, the system control unit 3101 commands the video processor 105 to perform telop area replacement.

The video processor 105 replaces the telop area as commanded by the system control unit 3101. The video processor 105 need not operate continuously; it may operate only command.

In this embodiment, telop area replacement is controlled by the system control unit 3101, and step S2501 in FIG. 22 is executed by the system control unit 3101.

A similar system control unit 3101 may be added to the video processing device in the eighth embodiment. In that case, the audio alert detector 2401, telop detector 102, and telop change detector 103 report their detection results to the system control unit 3101. When the telop change detector 103 detects the appearance of a telop, it may inform the system control unit 3101 of the appearance of the telop immediately, or provide the system control unit 3101 with information such as a time stamp or time indicating the timing at which the appearance of the telop was detected. When the telop change detector 103 detects the disappearance of the telop, the telop change detector 103 may also inform the system control unit 3101 of the disappearance of the telop, either immediately or by providing the system control unit 3101 with information such as a time stamp or time indicating the timing at which the disappearance of the telop was detected.

If the detection results reported from the audio alert detector 2401, telop detector 102, and telop change detector 103 indicate that the appearance of the telop has been detected within the first time period TP1 from the time at which an audio alert was detected, the system control unit 3101 controls the video processor 105 so that the video processor 105 performs replacement selectively, on telop areas detected within the second time period TP2 from the time of audio alert detection. For example, when the audio alert detector 2401 reports detection of an audio alert, the system control unit 3101 starts measuring the lapse of time from the time of audio alert detection, by using a timer or the like. When the telop change detector 103 reports detection of the appearance of a telop, the system control unit 3101 decides in accordance with the time measured by the timer whether the appearance of the telop was detected within the first time period TP1, indicating that an alert telop has appeared. When the telop detector 102 reports detection of a telop area, the system control unit 3101 decides in accordance with the time measured by the timer whether the telop area was detected within the second time period TP2 and, if so, has the video processor 105 perform telop area replacement.

In this variation of the eighth embodiment, accordingly, the system control unit 3101 determines which telop areas require replacement and executes steps S2901 to S2903 in FIG. 26.

A similar system control unit 3101 may be added to the video processing device in the ninth embodiment. In that case also, the audio alert detector 2401, telop detector 102, and telop change detector 103 report their detection results to the system control unit 3101. When these detection results indicate that the appearance of a telop has been detected within the designated time period from the time at which an audio alert was detected, the system control unit 3101 controls the video processor 105 so that it performs replacement selectively on telop areas including that particular telop, or a continuation thereof. For example, when the audio alert detector 2401 reports detection of an audio alert, the system control unit 3101 starts measuring the lapse of time from when the audio alert was detected, by using a timer or the like. When the telop change detector 103 reports detection of the appearance of a telop, the system control unit 3101 decides in accordance with the time measured by the timer whether the appearance of the telop was detected within the designated time period and, if so, decides that an alert telop has appeared and records the telop in the telop memory area. When the telop detector 102 reports detection of a telop area, the system control unit 3101 decides whether the telop area includes the recorded telop or a continuation thereof and, if so, has the video processor 105 perform telop area replacement. When the telop change detector 103 reports detection of the disappearance of a telop, the system control unit 3101 clears the telop memory area.

In this variation of the ninth embodiment, the system control unit 3101 determines which telop areas require replacement and executes steps S3001 to S3004 in FIG. 27.

In the exemplary methods described above, the lapse of time from audio alert detection is measured by a timer or the like. Alternatively, the system control unit 3101 may record the time or time stamp at which the audio alert was detected and may measure the lapse of time by taking the difference between the recorded time or time stamp and the time or time stamp at which the appearance of a telop or telop area is detected.

In the description given above, the video recording unit 101, telop detector 102, telop change detector 103, and recording controller 104 operate continuously. Alternatively, the system control unit 3101 may control the video recording unit 101, telop detector 102, telop change detector 103, and recording controller 104 so that some or all of them operate only within the relevant time periods from the detection of an audio alert by the audio alert detector 2401. For example, the telop detector 102 may be controlled so that it detects telop areas only in video frames within a designated time period following audio alert detection. This type of control can reduce the number of times detection processing and related processing is performed and consequently reduce the system processing load.

### Eleventh Embodiment

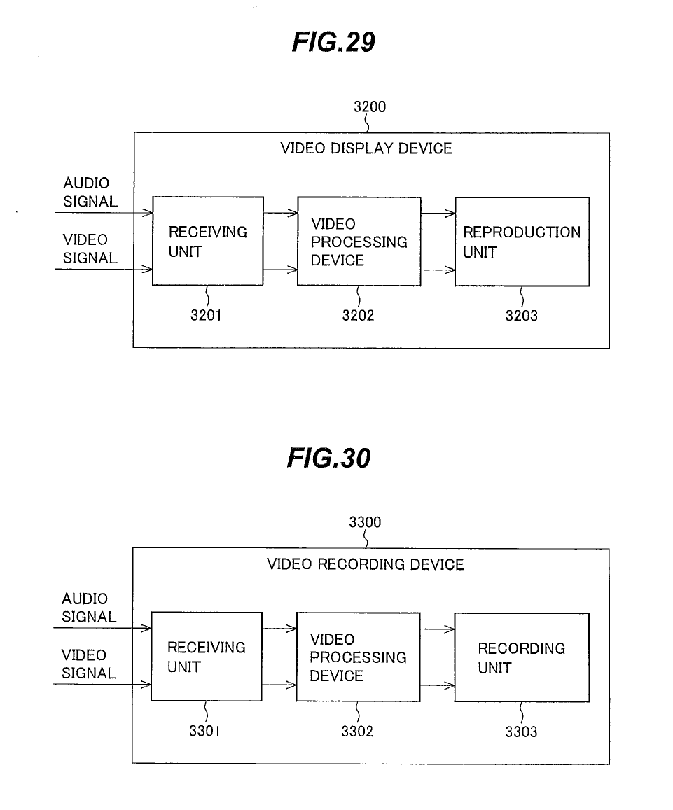

The eleventh embodiment is a video display device 3200, shown in FIG. 29, that processes and outputs audio and video signals. For example, the video display device 3200 may be a television set that receives audio and video television broadcast signals and provides picture and sound output. The video display device 3200 in FIG. 29 has a receiving unit 3201, a video processing device 3202, and a reproduction unit 3203. The reproduction unit 3203 may be external to the video display device 3200.

The receiving unit 3201 receives, for example, the audio and video signals of digital television broadcasts.

The video processing device 3202 operates as described in any of the preceding embodiments on the audio and video signals received by the receiving unit 3201 to replace telop areas, and outputs the processed audio and video signals. The video processing device 3202 may perform telop replacement as described in any of the first four embodiments, or may replace selectively, depending on whether the telop is associated with an emergency signal or data or an audio alert, as described in the fifth to tenth embodiments.

The reproduction unit 3203 reproduces the audio and video signals output from the video processing device 3202. For example, the reproduction unit 3203 provides picture and sound output in accordance with the output audio and video signals.

The video processing device 3202 may include an audio signal processor 2402 that alters the volume level of an audio alert or delays the audio signal for synchronization with the output picture, as described in the seventh embodiment.

### Twelfth Embodiment

The twelfth embodiment is a video recording device 3300, shown in FIG. 30, that processes and records audio and video signals. For example, the video recording device 3300 may be a broadcast video recorder that receives and records television broadcast signals. The video recording device 3300 in FIG. 30 has a receiving unit 3301, a video processing device 3302, and a recording unit 3303. The recording unit 3303 may be external to the video recorder 3300.

The receiving unit 3301 receives, for example, the audio and video signals of digital television broadcasts.

The video processing device 3302 operates as described in any of the preceding embodiments on the audio and video signals received by the receiving unit 3301 to replace telop areas, and outputs the processed audio and video signals. The video processing device 3302 may perform telop replacement as described in any of the first four embodiments, or may replace selectively as described in any of the fifth to tenth embodiments.

The recording unit 3303 records the audio and video signals output from the video processing device 3302 on a recording medium such as an optical disc or a hard disk.

The video processing device 3302 may include an audio signal processor 2402 that alters the volume level of an audio alert or delays the audio signal for synchronization with the output picture, as described in the seventh embodiment.

The video recording device 3300 may be a video recording and display device including a display unit for displaying the video signal output from the video processing device 3302 or the video signal recorded by the recording unit 3303 and an output unit for output of the audio signal output from the video processing device 3302 or the audio signal recorded by the recording unit 3303.

### Thirteenth Embodiment

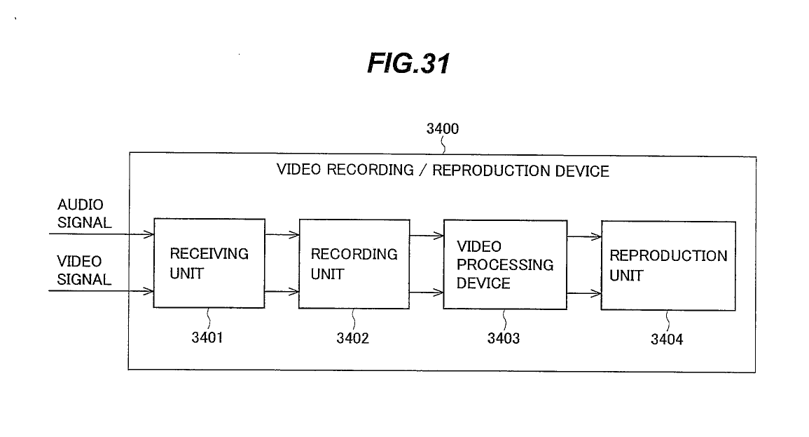

The thirteenth embodiment is a video recording/reproduction device 3400, shown in FIG. 31, that processes, records, and reproduces audio and video signals. For example, the video recording/reproduction device 3400 may be a video recorder that receives, records, and reproduces audio and video television broadcast signals. The video recording/reproduction device 3400 in FIG. 31 has a receiving unit 3401, a recording unit 3402, a video processing device 3403, and a reproduction unit 3404. The reproduction unit 3404 may be external to the video recording/reproduction device 3400.

The receiving unit 3401 receives, for example, the audio and video signals of digital television broadcasts.

The recording unit 3402 records the audio and video signals output from the receiving unit 3401 on a recording medium such as an optical disc or a hard disk.

The video processing device 3403 operates as described in any of the preceding embodiments on the audio and video signals recorded by the recording unit 3402 to replace telop areas, and outputs the processed audio and video signals. The video processing device 3403 may perform telop replacement as described in the first four embodiments, or may replace selectively as described in the fifth to tenth embodiments.

The reproduction unit 3404 reproduces the audio and video signals output from the video processing device 3403 and provides, for example, picture and sound output.

The video processing device 3403 may include an audio signal processor 2402 that alters the volume level of an audio alert or delays the audio signal for synchronization with the output picture, as described in the seventh embodiment.

The functions of the video processing devices in the first to thirteenth embodiments may be implemented purely by hardware resources such as electronic circuits, or may be implemented by cooperation between hardware resources and software resources. Each function of the video processing device implemented by cooperation between hardware and software resources may be implemented by, for example, executing a video processing program on a computer. More specifically, the relevant function of the video processing device may be stored as a video processing program in a storage medium such as a read-only memory (ROM), and the program may be read into the computer's main memory and executed by its central processing unit (CPU). The video processing program may also be recorded on a computer-readable recording medium such as an optical disc, or may be provided through a communication channel or network such as the Internet.

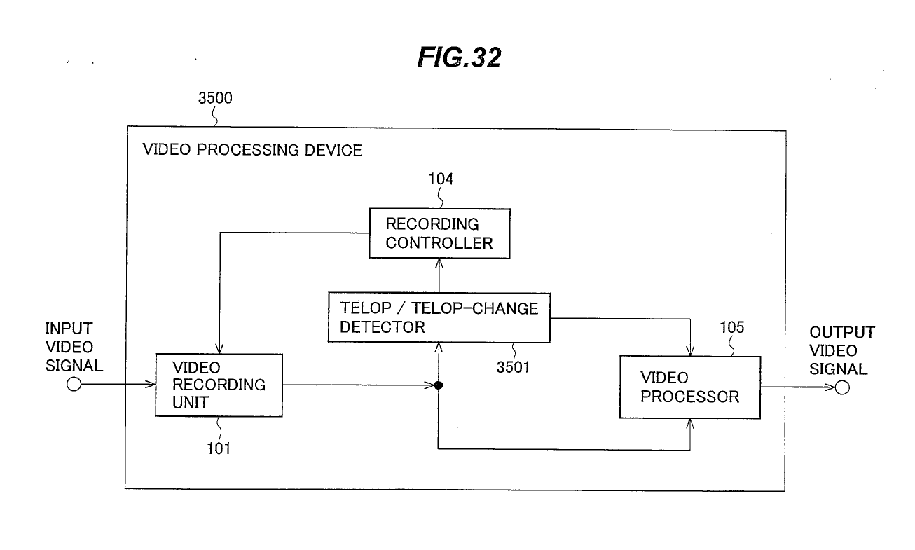

In any of the preceding embodiments, the telop detector 102 and telop change detector 103 may be combined into a telop/telop-change detector. For example, the video processing device 3500 in FIG. 32 includes a telop/telop-change detector 3501 instead of a telop detector 102 and telop change detector 103.

The configurations in the first to thirteenth embodiments may be combined in various ways. For example, the functions described in any of the seventh to tenth embodiments may be added to the video processing device in any of the second to sixth embodiments, so that the video processing device detects audio alerts and performs replacement selectively on the telop areas of telops accompanied by an audio alert. The video processing device in any of the second to sixth embodiments may also be configured to reduce the volume level of the audio alert in the input audio signal in accordance with the result of audio alert detection, as in the seventh to tenth embodiments. If the fourth embodiment and the tenth embodiment are combined, when a telop is recognized, the character recognizer 1801 communicates with the system control unit 3101 to see whether the telop has been detected within a designated time period from when an audio alert was detected and, if the detection time is within the designated time period, decides that the telop is present and sends the result of this decision to the telop detector 102.

It is contemplated that the video processor 105 in the preceding embodiments might use a substitute image derived from the pixels peripheral to the telop area in the video frame in which the replacement is made, instead of a substitute image derived from the video signal preceding the appearance of the telop. For example, the video processor 105 might replace telop T1 in FIG. 5 or FIG. 8 with a substitute image derived from pixels peripheral to the telop area. This substitute image would still be derived from a video signal of the same type as the video signal including the telop area.

In the preceding descriptions the input sequence of video frames are processed successively, in the order of the frames, but if the sequence of video frames are recorded on a recording medium, the video processing device may process them in any order. In the seventh to tenth embodiments, if the audio and video signals are recorded on a recording medium, the video processing device may process both the audio and video signals in any order.

In the seventh to tenth embodiments, time periods following audio alert detection were given as designated time periods near the detection of an audio alert, but these designated time periods may include both a period before the detection of the audio alert and a period after the detection of the audio alert. Each of the designated time periods may be predetermined and fixed, or variably determined by the video processing device based on the predetermined rules.

Those skilled in the art will recognize that further variations are possible within the scope of the invention, which is defined in the appended claims.

What is claimed is:

1. A video processing device comprising:
a telop detector for detecting a telop area including a telop in an input sequence of video frames;
an audio alert detector for detecting an audio alert from an input sequence of audio signals corresponding to the input sequence of video frames; and
a video processor for replacing a telop area in the video frame in which the telop area is detected with an image derived from a video frame preceding the video frame in which the telop of the telop area initially appears in the input sequence of video frames, and outputting the video frame in which the telop area has been replaced; wherein
the video processor selectively replaces the telop area of a telop accompanied by an audio alert detected by the audio alert detector.

2. The video processing device of claim 1, further comprising:
a telop change detector for detecting initial appearance of the telop in the sequence of video frames; and
a replacement video recording unit for recording the video frame preceding the video frame in which the telop initially appears, on a basis of a detection result produced by the telop change detector; wherein
the video processor replaces the telop area with an image derived from the video frame recorded by the replacement video recording unit.

3. The video processing device of claim 2, further comprising a video recording unit for receiving the input sequence of video frames in the order of the frames and recording a current video frame and a preceding video frame, wherein:
the telop detector detects the telop area in the recorded current video frame;
the telop change detector detects the initial appearance of the telop in the recorded current video frame;
when the telop change detector detects the initial appearance of the telop, the replacement video recording unit records the recorded preceding video frame as the video frame preceding the video frame in which the telop initially appears; and
when the telop detector detects the telop area, the video processor replaces the telop area in the current video frame with the image derived from the recorded video frame preceding the video frame in which the telop initially appears, and outputs the current video frame in which the telop area has been replaced.

4. The video processing device of claim 2, wherein:
the telop change detector detects, from the input sequence of video frames, both the initial appearance of the telop and cutovers of the telop to new telop content;
the video processor replaces the telop area with an image derived from the video frame preceding the video frame in which the telop initially appears provided the last detection result of the telop change detector preceding the video frame in which the replacement is made represents the initial appearance of the telop; and
the video processor replaces the telop area with an image derived from pixels peripheral to the telop area in the video frame in which the replacement is made if the last detection result of the telop change detector preceding the video frame in which the replacement is made represents a cutover of the telop.

5. The video processing device of claim 2, wherein the telop change detector detects edges of characters and character borders constituting the telop and detects the initial appearance of the telop or cutovers in the telop from changes in the detected edges.

6. The video processing device of claim 1, further comprising a scene change detector for detecting scene changes in the input sequence of video frames, wherein:
the video processor replaces the telop area with an image derived from the video frame preceding the video frame in which the telop initially appears provided the scene change detector does not detect a scene change between the video frame preceding the video frame in which the telop initially appears and the video frame in which the replacement is made; and
the video processor replaces the telop area with an image derived from pixels peripheral to the telop area in the video frame in which the replacement is made if the scene change detector detects a scene change between the video frame preceding the video frame in which the telop initially appears and the video frame in which the replacement is made.

7. The video processing device of claim 1, wherein the telop detector performs character recognition on the video frames and detects, as the telop area, an area found, as a result of the character recognition, to include character information.

8. The video processing device of claim 1, wherein replacement of the telop area is disabled when an emergency alert broadcast signal is received.

9. The video processing device of claim 1, wherein replacement of the telop area is disabled when a data broadcast signal including certain information is received.

10. The video processing device of claim 1, wherein the video processor selectively replaces the telop area during a predetermined period of time near a time at which the audio alert is detected.

11. The video processing device of claim 1, further comprising a telop change detector for detecting initial appearance of the telop in the sequence of video frames, wherein if the initial appearance of the telop is detected in a first predetermined time period near a time at which the audio alert is detected, the video processor selectively replaces the telop area during a second predetermined time period near the time at which the audio alert is detected.

12. The video processing device of claim 1, further comprising a telop change detector for detecting initial appearance of the telop in the sequence of video frames, wherein if the initial appearance of the telop is detected in a predetermined period of time near a time at which the audio alert is detected, the video processor selectively replaces the telop area including the telop whose initial appearance was detected.

13. The video processing device of claim 1, further comprising an audio signal processor for reducing a volume level of the audio alert detected by the audio alert detector.

14. A video display device comprising:
the video processing device of claim 1; and
a reproduction unit for displaying video frames output from the video processor in the video processing device.

15. A video recording device comprising:
the video processing device of claim 1; and
a recording unit for recording video frames output from the video processor in the video processing device.

16. A method of processing an input sequence of video frames, comprising:
detecting a telop area including a telop in an input sequence of video frames;
detecting an audio alert from an input sequence of audio signals corresponding to the input sequence of video frames; and
replacing a telop area in the video frame in which the telop area is detected with an image derived from a video frame preceding the video frame in which the telop initially appears in the input sequence of video frames, and outputting the video frame in which the telop area has been replaced; wherein
the telop area of a telop accompanied by an audio alert detected in the audio alert detection is selectively replaced.

17. A machine-readable recording medium storing a program executable by a computer, the program including:
instructions for detecting a telop area including a telop in an input sequence of video frames;
instructions for detecting an audio alert from an input sequence of audio signals corresponding to the input sequence of video frames; and
instructions for replacing a telop area in the video frame in which the telop area is detected with an image derived from a video frame preceding the video frame in which the telop initially appears in the input sequence of video frames, and outputting the video frame in which the telop area has been replaced; wherein
the telop area of a telop accompanied by an audio alert detected in the audio alert detection is selectively replaced.
